(19) United States
(12) Patent Application Publication
(10) Pub. No.: US 2024/0233777 A1
(43) Pub. Date: Jul. 11, 2024

(54) INFORMATION PROCESSING APPARATUS, INFORMATION PROCESSING METHOD, INFORMATION PROCESSING PROGRAM, AND INFORMATION PROCESSING SYSTEM

(71) Applicant: SONY GROUP CORPORATION, TOKYO (JP)

(72) Inventor: JUNICHI SHIMIZU, TOKYO (JP)

(21) Appl. No.: 18/559,391

(22) PCT Filed: Feb. 17, 2022
(86) PCT No.: PCT/JP2022/006332

§ 371 Date: Nov. 7, 2023

(30) Foreign Application Priority Data
May 26, 2021 (JP) 2021-088465

(51) Int. Cl. G11B 27/10; G10K 15/02; H04R 3/00

(52) U.S. Cl. CPC G11B 27/10; G10K 15/02; H04R 3/00

(57) ABSTRACT

An information processing apparatus (10) according to an embodiment includes: a content acquisition unit (102) that acquires target content data, a context acquisition unit (101) that acquires context information of a user, and a generation unit (102) that generates, based on the target content data and the context information, playback content data in which a parameter for controlling playback of the target content data is changed.

### FIELD

The present disclosure relates to an information processing apparatus, an information processing method, an information processing program, and an information processing system.

### BACKGROUND

Performing work in an environment in which appropriately selected music is being played back sometimes improves work efficiency. In this case, it is preferable to vary, according to an action of a user who perform the work, for example, during work or during breaks, music to be played back. Patent Literature 1 describes a technique for controlling playback of content according to a moving motion of a user.

### CITATION LIST

### Patent Literature

Patent Literature 1: WO 2020/090223 A

### SUMMARY

### Technical Problem

In an existing package medium recorded in a recording medium and distributed or distributed by a distribution service, since a composition of music is determined in advance, it is difficult to dynamically generate or arrange music corresponding to an action of a user. When a detection result of detecting an action of the user is directly fed back to music, it is likely that the music excessively changes to give discomfort to the user and it is sometimes difficult to maintain musicality.

An object of the present disclosure is to provide an information processing apparatus, an information processing method, an information processing program, and an information processing system capable of playing back music corresponding to an action of a user.

### Solution to Problem

For solving the problem described above, an information processing apparatus according to one aspect of the present disclosure has a content acquisition unit that acquires target content data; a context acquisition unit that acquires context information of a user; and a generation unit that generates, based on the target content data and the context information, playback content data in which parameters are changed in order to control playback of the target content data.

For solving the problem described above, an information processing apparatus according to one aspect of the present disclosure has a control unit that divides content data into a plurality of portions based on a composition in a time-series direction and correlates context information with each of the divided plurality of portions according to user operation.

For solving the problem described above, an information processing system according to one aspect of the present disclosure has a first terminal device including a control unit that divides content data into a plurality of portions based on a composition in a time-series direction and correlates context information with each of the divided plurality of portions according to user operation; and a second terminal device including: a content acquisition unit that acquires target content data; a context acquisition unit that acquires the context information of a user; and a generation unit that generates, based on the target content data and the context information, playback content data in which a parameter for controlling playback of the target content data is changed.

### BRIEF DESCRIPTION OF DRAWINGS

FIG. 1 is a schematic diagram for schematically explaining processing by an information processing system according to an embodiment of the present disclosure.

FIG. 2 is a schematic diagram illustrating a configuration of an example of an information processing system applicable to the embodiment.

FIG. 3 is a block diagram illustrating a configuration of an example of a user terminal applicable to the embodiment.

FIG. 4 is a block diagram illustrating a hardware configuration of an example of a creator terminal applicable to the embodiment.

FIG. 5 is a functional block diagram of an example for explaining functions of the user terminal according to the embodiment.

FIG. 6 is a functional block diagram of an example for explaining functions of the creator terminal according to the embodiment.

FIG. 7 is a schematic diagram for explaining a first processing example in the user terminal according to the embodiment.

FIG. 8 is a flowchart of an example illustrating changing processing for a composition of a tune by the first processing example according to the embodiment.

FIG. 9 is a schematic diagram illustrating an example in which a composition is changed using content data created by a plurality of creators according to the embodiment.

FIG. 10 is a schematic diagram illustrating an example of playback content data generated based on designation by a user according to the embodiment.

FIG. 11A is a schematic diagram for explaining generation processing for playback content data corresponding to an experience time of the user according to the embodiment.

FIG. 11B is a schematic diagram for explaining the generation processing for playback content data corresponding to an experience time of the user according to the embodiment.

FIG. 12 is a flowchart of an example illustrating the generation processing for playback content data corresponding to the experience time of the user according to the embodiment.

FIG. 13 is a flowchart of an example illustrating crossfade processing applicable to the embodiment.

FIG. 14A is a schematic diagram for explaining a second processing example in the user terminal according to the embodiment.

FIG. 14B is a schematic diagram for explaining the second processing example in the user terminal according to the embodiment.

FIG. 15 is a flowchart of an example illustrating changing processing for a composition of sound by the second processing example according to the embodiment.

FIG. 16 is a schematic diagram for explaining a modification of the second processing example according to the embodiment.

FIG. 17 is a flowchart of an example illustrating changing processing for a composition of sound by a modification of the second processing example according to the embodiment.

FIG. 18A is a schematic diagram illustrating an example of a user interface applicable to the embodiment.

FIG. 18B is a schematic diagram illustrating an example of a user interface applicable to the embodiment.

FIG. 18C is a schematic diagram illustrating an example of a user interface applicable to the embodiment.

FIG. 19 is a schematic diagram illustrating an example of a track selection screen for selecting a track according to the embodiment.

FIG. 20 is a schematic diagram illustrating an example of a track selection screen in the case in which track automatic allocation is applied according to the embodiment.

FIG. 21 is a schematic diagram illustrating an example of a UI for calculating an experience time of a tune applicable to the embodiment.

FIG. 22A is a schematic diagram for explaining registration of a material and context information for the material according to the embodiment.

FIG. 22B is a schematic diagram for explaining correlation between parts and parameters for giving a music change according to the embodiment.

FIG. 22C is a schematic diagram for explaining correlation of a maximum playback time with track groups according to the embodiment.

FIG. 22D is a schematic diagram illustrating an example of visualized display obtained by visualizing correlations according to the embodiment.

FIG. 23 is a schematic diagram illustrating variations of tagging for created materials according to the embodiment.

### DESCRIPTION OF EMBODIMENT

An embodiment of the present disclosure is explained in detail below with reference to the drawings. Note that, in the embodiment explained below, redundant explanation is omitted by denoting the same parts with the same reference numerals and signs.

An embodiment of the present disclosure is explained in detail below according to the following order.
1. Overview of the embodiment of the present disclosure
2. Configuration applicable to the embodiment
3. Processing in a user terminal according to the
embodiment
3-1. First processing example
3-1-1. Example in which a plurality of creator works are
used
3-1-2. Example of content generation corresponding to an
experience time
3-1-3. Example of crossfade processing
3-2. Second processing example
3-2-1. Modification of the second processing example
3-3. Example of a UI in the user terminal
4. Processing in a creator terminal according to the
embodiment
4-1. Example of a UI for allocating audio data to tracks
4-2. Example of a UI for experience time calculation
4-3. Example of a UI for performing tagging for tune data
4-4. Example of correlation of context information with
tune data
4-5. Variations of tagging for tune data
4-6. Variations of music changes

### [1. Overview of the Embodiment of the Present Disclosure]

First, the embodiment of the present disclosure is schematically explained. As an example, the present disclosure relates to an environment at the time when a user works in an environment such as at home. The present disclosure adaptively provides content according to context information of the user.

More specifically, an information processing system according to the embodiment of the present disclosure acquires target content data, which is data of content to be played back. The information processing system acquires context information indicating context of the user. The information processing system changes a parameter for controlling playback of the target content data and generates playback content data based on the target content data and the context information. By playing back the playback content data generated by changing the parameter according to the acquisition of the context information of the user, it is possible to provide content suitable for work or the like to the user.

Note that, in the following explanation, content data is explained as music data for playing back music. Not only this, but the embodiment of the present disclosure may apply video data (moving image data) for playing back a video (a moving image) as content data or may apply data including music data and video data. The content data may be data other than the data explained above such as voice data. Note that the voice data includes data for playing back sound (natural sound such as wave sound, rain sound, and stream sound, human voice, machine sound, . . . , and the like) different from what is generally called music. In the following explanation, when it is unnecessary to distinguish the target content data and the playback content data, these data are simply explained as “content data” as appropriate.

Note that music includes a combination of one or more sounds and is played back in units of a tune. In general, a tune is composed by arraying one or more parts characterized by melodies, rhythms, harmonies, tones (keys), and the like in a time-series direction. In addition, a plurality of same parts can be arranged in one tune. A part can include repetition of a predetermined pattern or phrase by a part or all of sounds (elements) composing the part.

It is assumed that a context of the user indicates, for example, a series of motions of the user in work or the like performed by the user and context information is information schematically indicating motions of the user in scenes in the series of motions.

For example, in an example in which the user performs work in a room at home, it is assumed that the user performs motions of [1] entering a room (enter a room), [2] walking around the room to prepare for work (work preparation), [3] sitting in front of a desk to start the work (start work), [4] absorbed in the work (working), and [5] standing up for a break (break). In this case, a series of motions [1] to [5] by the user is a context of this work of the user and information (for example, “enter a room”, “work preparation”, “start work”, “working”, and “break”) indicating the motions (scenes) in the context is context information. Note that the context and the context information explained above are examples and are not limited to the examples.

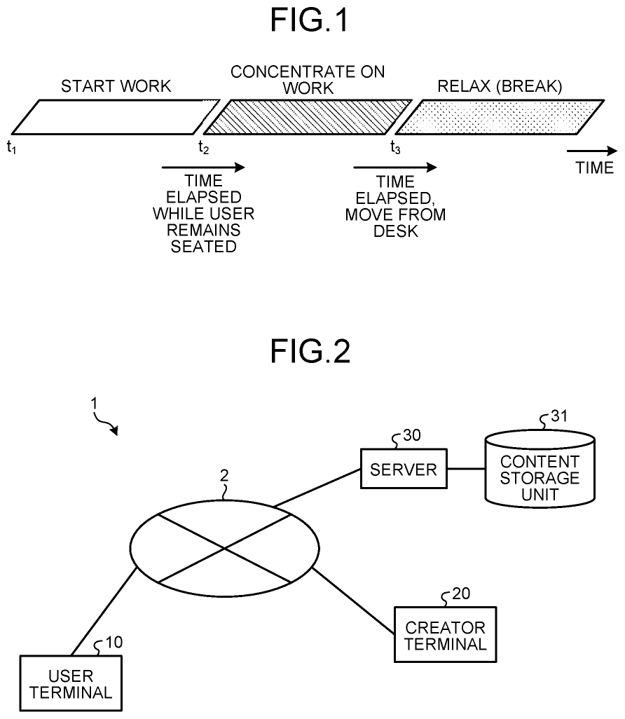

FIG. 1 is a schematic diagram for schematically explaining processing by the information processing system according to the embodiment of the present disclosure. In FIG. 1, it is assumed that the user performs the motions (“enter a room”, “work preparation”, “start work”, “working”, “break”) corresponding to the context information shown in [1] to [5] explained above. It is assumed that the user carries, for example, a smartphone as a user terminal relating to the information processing system. It is assumed that the smartphone includes sensing means by various sensors such as a gyro sensor, an acceleration sensor, and a camera and is capable of detecting the position and posture (the motion) of the user.

At time t₁, the user designates, to the information processing system, a tune to be played back, to start work, enters a room where the user performs the work, and walks around the room to prepare for the work. These motions are detected by the various sensors of the user terminal. The information processing system according to the embodiment plays back the tune designated by the user. At this time, the information processing system changes a parameter for controlling the playback of the tune based on context information corresponding to the motion detection by the various sensors and generates or selects and plays back, based on the tune being played back, for example, tune data that uplifts the user's mood.

Note that the tune data includes various data concerning the tune such as audio data for playing back the tune, a parameter for controlling playback of the audio data, and metadata indicating characteristics of the tune.

At time t₂, the user is ready for work and sits in front of the desk to start work. A standstill of the user is detected by the various sensors of the user terminal. When the work is started, time elapses, for example, while the user remains seated. The information processing system changes a parameter for controlling playback of a tune according to context information corresponding to the standstill detection by the various sensors and generates or selects and plays back, based on a tune designated by the user, tune data for urging concentration of the user. As an example, it is conceivable that, for example, the information processing system suppresses movement of sound and generates minimal tune data in which a patterned sound type is repeated.

It is assumed that, from time t₂ until time t₃ when a predetermined time elapses, the standstill of the user is detected by the various sensors and a motion of the user standing up and moving from the desk is detected at time t₃. The information processing system changes, according to context information of contexts in which the motion of the user standing up and moving after the stillness of the user is detected continuously for a predetermined time, a parameter for controlling playback of a tune and generates or selects and plays back, based on a tune designated by the user, a tune for urging the user to take a break, for example, tune data that enables the user to relax. Not only this, but audio data itself of natural sound may be selected and played back as tune data that enables the user to relax.

As explained above, the information processing system according to the embodiment of the present disclosure detects a motion of the user, changes, based on context information corresponding to the detected motion, the parameter for controlling playback of a tune, and generates or selects, based on a designated tune, tune data of the tune to be played back. Therefore, it is possible to provide content (music in this example) suitable for work or the like to the user.

When viewed from the user side, by applying the information processing system according to the embodiment of the present disclosure, effects such as easy concentration on work, sharpness of concentration and relaxation, and easy time management can be expected.

### [2. Configuration Applicable to the Embodiment]

Subsequently, a configuration applicable to the embodiment is explained. FIG. 2 is a schematic diagram illustrating a configuration of an example of an information processing system applicable to the embodiment. In FIG. 2, an information processing system 1 according to the embodiment includes a user terminal 10, a creator terminal 20, and a server 30 communicably connected to one another by a network 2 such as the Internet.

The user terminal 10 is a terminal device used by a user who listens to music played back by the information processing system 1. As the user terminal 10, an information processing apparatus such as a smartphone, a tablet computer, or a personal computer can be applied. The information processing apparatus applicable as the user terminal 10 is not particularly limited if a sound playback function and a sensor that detects a state of the user are built in or connected to the information processing apparatus.

The creator terminal 20 is a terminal device used by a user who creates music (a tune) to be provided to the user by the information processing system 1. As the creator terminal 20, it is conceivable to apply a personal computer. However, not only this, but a smartphone or a tablet computer may be applied as the creator terminal 20.

Note that, in the embodiment, since the user does not play back music with the information processing system 1 for the purpose of listening, a term “experience” is used instead of “listening” in the following explanation. In the following explanation, a user who creates music (a tune) to be provided to the user is referred to as a “creator” and is distinguished from a “user” who experiences the music with the information processing system 1.

The server 30 acquires tune data created by the creator terminal 20 and stores and accumulates the tune data in a content storage unit 31. The user terminal 10 acquires the tune data stored in the content storage unit 31 from the server 30 and plays back the music data.

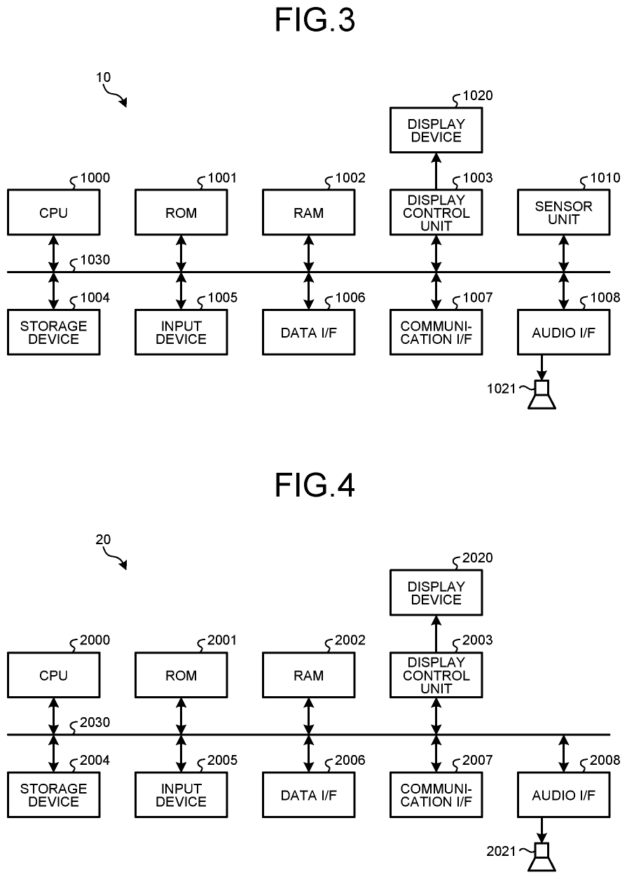

FIG. 3 is a block diagram illustrating a hardware configuration of an example of the user terminal 10 applicable to the embodiment. Here, a smartphone is assumed as the user terminal 10. Note that, in FIG. 3, since a call function and a telephone communication function of the smartphone are not closely related to the embodiment, explanation thereof is omitted here.

In FIG. 3, the user terminal 10 includes a CPU (Central Processing Unit)1000, a ROM (Read Only Memory)1001, a RAM (Random Access Memory) 1002, a display control unit 1003, a storage device 1004, an input device 1005, a data I/F (interface) 1006, a communication I/F 1007, an audio I/F 1008, and a sensor unit 1010 communicably connected to one another via a bus 1030.

The storage device 1004 is a nonvolatile storage medium such as a flash memory or a hard disk drive. The CPU 1000 operates using the RAM 1002 as a work memory according to a program stored in the ROM 1001 and the storage device 1004 and controls an operation of the entire user terminal 10.

The display control unit 1003 generates, based on a display control signal generated by the CPU 1000 according to a program, a display signal that can be treated by a display device 1020. The display device 1020 includes, for example, an LCD (Liquid Crystal Display) or an organic EL (Electro Luminescence) display and a driver circuit therefor and displays a screen corresponding to a display signal supplied from the display control unit 1003.

The input device 1005 receives user operation and passes a control signal corresponding to the received user operation to, for example, the CPU 1000. As the input device 1005, a touch pad that outputs a control signal corresponding to a touched position can be applied. The input device 1005 and the display device 1020 may be integrally formed to configure a touch panel.

The data I/F 1006 controls transmission and reception of data by wired communication or wireless communication between the user terminal 10 and external equipment. For example, a USB (Universal Serial Bus) or Bluetooth (registered trademark) can be applied as the data I/F 1006. The communication I/F 1007 controls communication with the network 2.

The audio I/F 1008 converts, for example, digital audio data supplied via the bus 1030 into an analog audio signal and outputs the analog audio signal to a sound output device 1021 such as a speaker or an earphone. Note that the audio data can also be output to the outside via the data I/F 1006.

The sensor unit 1010 includes various sensors. For example, the sensor unit 1010 includes a gyro sensor and an acceleration sensor and can detect the posture and position of the user terminal 10. The sensor unit 1010 includes a camera and can photograph the periphery of the user terminal 10. The sensors included in the sensor unit 1010 are not limited these sensors. For example, the sensor unit 1010 can include a distance sensor and a voice sensor (a microphone). Further, the sensor unit 1010 can include a receiver for a signal by a GNSS (Global Navigation Satellite System) and the like and, in this case, can acquire the position of the user terminal 10 using the GNSS. Note that, for example, when the communication I/F 1007 performs communication by Wi-Fi (Wireless Fidelity) (registered trademark), the position of the user terminal 10 can also be acquired based on this communication.

FIG. 4 is a block diagram illustrating a hardware configuration of an example of the creator terminal 20 applicable to the embodiment. Here, a general personal computer is applied as the creator terminal 20.

In FIG. 4, the creator terminal 20 includes a CPU (Central Processing Unit)2000, a ROM (Read Only Memory) 2001, a RAM (Random Access Memory) 2002, a display control unit 2003, a storage device 2004, an input device 2005, a data I/F (interface) 2006, a communication I/F 2007, and an audio I/F 2008 communicably connected to one another by a bus 2030.

The storage device 2004 is a nonvolatile storage medium such as a flash memory or a hard disk drive. The CPU 2000 operates using the RAM 2002 as a work memory according to a program stored in the ROM 2001 and the storage device 2004 and controls an operation of the entire creator terminal 20.

The display control unit 2003 generates, based on a display control signal generated by the CPU 2000 according to a program, a display signal that can be treated by a display device 2020. The display device 2020 includes, for example, an LCD, an organic EL display, and a driver circuit therefor and displays a screen corresponding to a display signal supplied from the display control unit 2003.

The input device 2005 receives user operation and passes a control signal corresponding to the received user operation to, for example, the CPU 2000. As the input device 2005, a pointing device such as a mouse and a keyboard can be applied. Not only this, but a touch pad can be applied as the input device 2005.

The data I/F 2006 controls transmission and reception of data by wired communication or wireless communication between the creator terminal 20 and external equipment. For example, a USB or Bluetooth (registered trademark) can be applied as the data I/F 2006. The communication I/F 2007 controls communication with the network 2.

The audio I/F 2008 converts, for example, audio data supplied via the bus 2030 into an analog audio signal and outputs the audio signal to a sound output device 2021 such as a speaker or an earphone. Note that the digital audio signal can also be output to the outside via the data I/F 2006. The audio I/F 2008 can convert an analog audio signal input from a microphone or the like into audio data and output the audio data to the bus 2030.

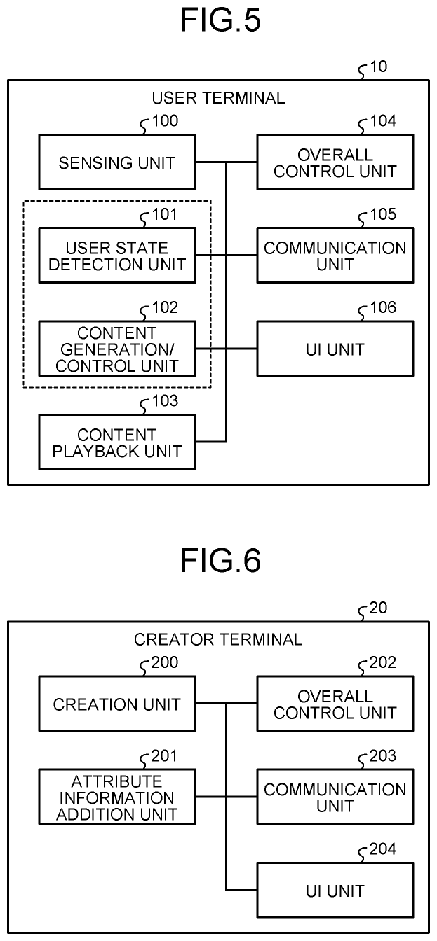

FIG. 5 is a functional block diagram of an example for explaining functions of the user terminal 10 according to the embodiment. In FIG. 5, the user terminal 10 includes a sensing unit 100, a user state detection unit 101, a content generation/control unit 102, a content playback unit 103, an overall control unit 104, a communication unit 105, and a UI (User Interface) unit 106.

The sensing unit 100, the user state detection unit 101, the content generation/control unit 102, the content playback unit 103, the overall control unit 104, the communication unit 105, and the UI unit 106 are configured by an information processing program for the user terminal 10 being executed on the CPU 1000. Not only this, but a part or all of the sensing unit 100, the user state detection unit 101, the content generation/control unit 102, the content playback unit 103, the overall control unit 104, the communication unit 105, and the UI unit 106 may be configured by hardware circuits that operate in cooperation with one another.

In FIG. 5, the overall control unit 104 controls the operation of the entire user terminal 10. The communication unit 105 controls communication with the network 2. The UI unit 106 presents a user interface. More specifically, the UI unit 106 controls display on the display device 1020 and controls operations of the units of the user terminal 10 according to user operation on the input device 1005.

The sensing unit 100 controls various sensors included in the sensor unit 1010 to perform sensing and collects sensing results by the various sensors. The user state detection unit 101 detects, based on sensing results by the various sensors collected by the sensing unit 100, a state of the user who is using the user terminal 10. The user state detection unit 101 detects, for example, movement of the user, behavior of the user such as sitting and standing, whether the user is standing still, and the like as the user state. As explained above, the user state detection unit 101 functions as a context acquisition unit that acquires context information of the user.

The content generation/control unit 102 controls playback of content (for example, a tune) by content data (for example, tune data) according to the user state detected by the user state detection unit 101. For example, the content generation/control unit 102 acquires, target content data of a playback target, for example, content data stored in the content storage unit 31 from the server 30 according to control of the UI unit 106 corresponding to user operation. The content generation/control unit 102 acquires metadata of the target content data and a parameter for controlling playback of the target content data incidentally to the target content data. The content generation/control unit 102 changes the parameter based on the acquired metadata and the context information of the user and generates playback content data based on the target content data.

As explained above, the content generation/control unit 102 functions as a content acquisition unit that acquires the target content data. At the same time, the content generation/control unit 102 also functions as a generation unit that changes a parameter for controlling playback of the target content data and generates playback content data based on the target content data and the context information

The content playback unit 103 plays back the playback content data generated by the content generation/control unit 102.

In the user terminal 10, an information processing program for the user terminal 10 according to the embodiment is executed, whereby the CPU 1000 configures, on a main storage region in the RAM 1002, respectively as, for example, modules, at least the user state detection unit 101, the content generation/control unit 102, and the UI unit 106 among the sensing unit 100, the user state detection unit 101, the content generation/control unit 102, the content playback unit 103, the overall control unit 104, the communication unit 105, and the UI unit 106 explained above.

The information processing program for the user terminal 10 can be acquired from the outside (for example, the server 30) via, for example, the network 2, by communication via, for example, the communication I/F 1007 and can be installed on the user terminal 10. Not only this, but the information processing program for the user terminal 10 may be provided by being stored in a detachable storage medium such as a CD (Compact Disk), a DVD (Digital Versatile Disk), or a USB (Universal Serial Bus) memory.

Note that, in the configuration illustrated in FIG. 5, the functions of the user state detection unit 101 and the content generation/control unit 102 surrounded by a dotted line frame may be configured as functions on the server 30.

FIG. 6 is a functional block diagram of an example for explaining functions of the creator terminal 20 according to the embodiment. In FIG. 6, the creator terminal 20 includes a creation unit 200, an attribute information addition unit 201, an overall control unit 202, a communication unit 203, and a UI unit 204.

The creation unit 200, the attribute information addition unit 201, the overall control unit 202, the communication unit 203, and the UI unit 204 are configured by an information processing program for the creator terminal 20 according to the embodiment being executed on the CPU 2000. Not only this, but a part or all of the creation unit 200, the attribute information addition unit 201, the overall control unit 202, the communication unit 203, and the UI unit 204 may be configured by hardware circuits that operate in cooperation with one another.

In FIG. 6, the overall control unit 202 controls an operation of the entire creator terminal 20. The communication unit 203 controls communication with the network 2. The UI unit 204 presents a user interface. More specifically, the UI unit 204 controls display on the display device 2020 and controls operations of the units of the creator terminal 20 according to user operation on the input device 2005.

The creation unit 200 creates content data (for example, tune data) according to, for example, an instruction of the UI unit 204 corresponding to user operation. The creation unit 200 can detect parts composing a tune from the created content data and correlate context information with the detected parts. The creation unit 200 can calculate playback times of the detected parts and can add information indicating positions of the parts to the content data as, for example, tags. The tags can be included in, for example, a parameter for controlling playback of the content data.

As explained above, the creation unit 200 functions as a control unit that divides the content data into a plurality of portions based on a composition in a time-series direction and correlates the context information with each of the divided plurality of portions according to user operation.

Further, the creation unit 200 can separate, from content data including a plurality of, for example, musical tones, audio data by the musical tones (sound source separation). Here, the musical to indicates a material of sound composing a tune such as a musical instrument, a human voice (such as vocal), and various sound effects included in the tune. Not only this, but the content data may include audio data of the materials respectively as independent data.

The attribute information addition unit 201 acquires attribute information of the content data created by the creation unit 200 and correlates the acquired attribute information with the content data. The attribute information addition unit 201 can acquire, for example, metadata for the content data as attribute information of the content data. The metadata concerns, for example, a tune by the content data and can include static information concerning the content data such as a composition (a part composition) in the time-series direction, a tempo (BPM: Beat Per Minute), a combination of sound materials, a tone (a key), and a type (a genre). The metadata can include information of a group obtained by mixing on a plurality of sound materials.

The attribute information addition unit 201 can acquire a parameter for controlling playback of the content data as attribute information of the content data. The parameter can include, for example, information for controlling a composition (a part composition) in the time-series direction of a tune by the content data, a combination of elements of sound included in parts, crossfade processing, and the like. Values included in these parameters are, for example, values that can be changed by the content generation/control unit 102 of the user terminal 10. Values added to the content data by the attribute information addition unit 201 can be treated as, for example, initial values.

In the creator terminal 20, the information processing program for the creator terminal 20 according to the embodiment is executed, whereby the CPU 2000 configures the creation unit 200, the attribute information addition unit 201, the overall control unit 202, the communication unit 203, and the UI unit 204 explained above on a main storage region of the RAM 2002 respectively as, for example, modules.

The information processing program for the creator terminal 20 can be acquired from the outside (for example, the server 30) via, for example, the network 2 by communication via the communication I/F 2007 and can be installed on the creator terminal 20. Not only this, but the information processing program for the creator terminal 20 may be provided by being stored in a detachable storage medium such as a CD (Compact Disk), a DVD (Digital Versatile Disk), or a USB (Universal Serial Bus) memory.

### [3. Processing in the User Terminal According to the Embodiment]

Subsequently, processing in the user terminal 10 according to the embodiment is explained. In the following explanation, the processing in the user terminal 10 is roughly divided into a first processing example and a second processing example and explained.

### (3-1. First Processing Example)

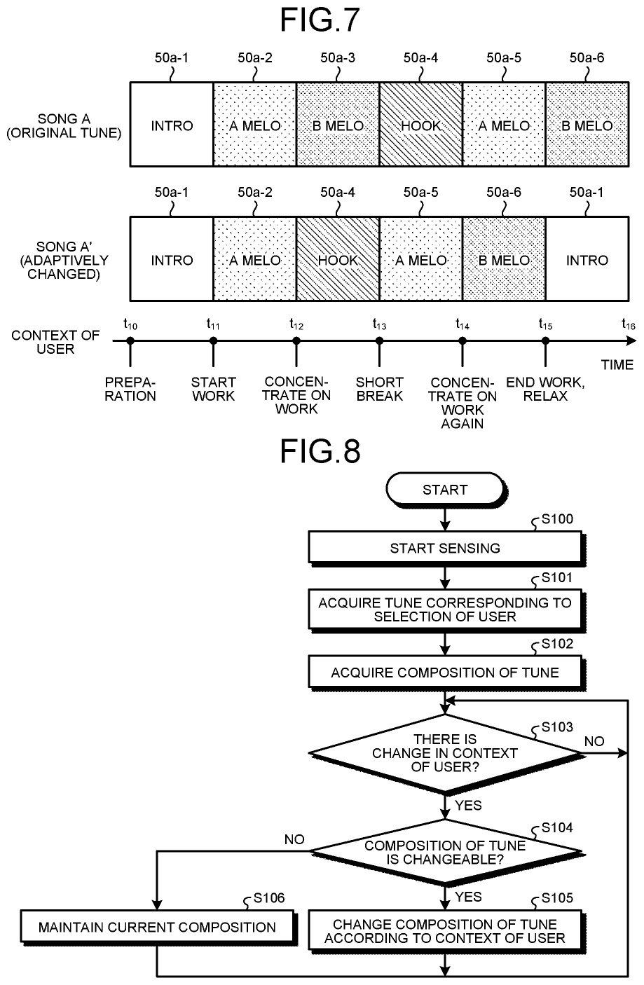

First, a first processing example in the user terminal 10 according to the embodiment is explained. FIG. 7 is a schematic diagram for explaining a first processing example in the user terminal 10 according to the embodiment. An upper part of FIG. 7 illustrates an example of target content data to be played back, which is, for example, acquired from the server 30. In this example, the target content data is data for playing back a tune “a song A”, which is an original tune.

In FIG. 7, the tune (the song A) by the target content data includes a plurality of parts 50a-1 to 50a-6 arrayed in the time-series direction. In this example, parts 50a-1 to 50a-6 are respectively “Intro” (prelude), “A Melo” (first melody), “B Melo” (second melody), “rust”, “A Melo”, and “B Melo”.

The content generation/control unit 102 can detect dividing positions of the parts 50a-1 to 50a-6 in the target content data based on characteristics of the audio data serving as the target content data. Not only this, but the creator who created the target content data may add, for example, as metadata, information indicating the dividing positions of the parts 50a-1 to 50a-6 to the target content data. The content generation/control unit 102 can extract the parts 50a-1 to 50a-6 from the target content data based on the information indicating the dividing positions of the parts 50a-1 to 50a-6 in the target content data. The information indicating the dividing positions of the parts 50a-1 to 50a-6 in the target content data is an example of information indicating the composition in the time-series direction of the target content data.

Context information is correlated with the parts 50a-1 to 50a-6 in advance. In this example, although not illustrated, it is assumed that context information “preparation” is correlated with the part 50a-1, context information “start work” is correlated with the parts 50a-2 and 50a-5, and context information “working” is correlated with the parts 50a-3 and 50a-6. It is assumed that context information “concentrate on work” is correlated with the part 50a-4.

The content generation/control unit 102 can change the composition in the time-series direction of the target content data based on the context information of the user detected by the user state detection unit 101. For example, when a clear change is detected in a context of the user based on the context information, the content generation/control unit 102 can replace a part being played back with a different part of the target content data, that is, change the order of parts and perform playback. Consequently, the content data can be presented to the user such that the change in the context can be easily understood.

A lower part of FIG. 7 illustrates an example of a change in the context of the user. In this example, the user prepares for work at time t₁₀ and starts the work at time t₁₁. The user concentrates on the work from time t₁₂ and shifts to a short break at time t₁₃. The user concentrates on the work again at time t₁₄, the work is finished at time t₁₅, and the user is relaxed.

The user state detection unit 101 can detect a change in the context of the user by quantifying the magnitude of a motion of the user based on a sensing result of the sensing unit 100 to obtain the magnitude of the motion as a degree of the motion and performing threshold determination on the degree of the motion. At this time, the magnitude of the motion of the user can include a motion of not moving the position of the user (such as sitting and standing) and movement of the position of the user.

The content generation/control unit 102 can rearrange the composition of the original tune according to the change in the context of the user. A middle part of FIG. 7 illustrates an example of a tune (a song A′) by the playback content data generated by the content generation/control unit 102 changing the order of the parts 50a-1 to 50a-6 included in the target content data according to the change in the context illustrated in the lower part of FIG. 7.

As illustrated in the middle part of FIG. 7, the content generation/control unit 102 replaces the part 50a3 of the original tune with the part 50a-4 correlated with the context information “concentrate on work” according to the context “concentrate on work” of the user at time t₁₂. On the other hand, the content generation/control unit 102 replaces the part 50a-4 of the original tune with the part 50a-5 correlated with the context information “start work” according to the context “short break” of the user at time t₁₃.

As explained above, the content generation/control unit 102 can executes, based on the information designated in advance by the creator side, the rearrangement of the order of the parts 50a-1 to 50a-6 corresponding to the context of the user. In this case, the creator can designate, to the parts 50a-1 to 50a-6, a part of a transition destination and a condition of the transition in advance. For example, the creator can designate, to a certain part, in advance, a part of a transition destination, for example, at the time when context information transitions to “concentrate on work” or when the same content information continues for a fixed time.

FIG. 8 is a flowchart of an example illustrating change processing for a composition of a tune by a first processing example according to the embodiment.

In step S100, in the user terminal 10, the sensing unit 100 starts sensing a state of the user. The user state detection unit 101 detects a context of the user based on a result of the sensing and acquires context information.

In the next step S101, the content generation/control unit 102 acquires, as target content data, content data (for example, tune data) stored in the content storage unit 31 from the server 30 according to an instruction corresponding to user operation by the UI unit 106.

In the next step S102, the content generation/control unit 102 acquires a composition of a tune by the target content data acquired in step S101. More specifically, the content generation/control unit 102 detects parts from the target content data. The content generation/control unit 102 may analyze audio data serving as the target content data to detect the parts or may detect the parts based on information indicating a composition of a tune added as, for example, metadata to the target content data by the creator.

In the next step S103, the user state detection unit 101 determines, based on a result of the sensing by the sensing unit 100 started in step S100, whether there is a change in the context of the user. For example, if a degree of a motion of the user is equal to or greater than a threshold, the user state detection unit 101 determines that there is a change in the context of the user. When determining that there is no change in the context of the user (step S103, “No”), the user state detection unit 101 returns the processing to step S103. On the other hand, when determining that there is a change in the context of the user (step S103, “Yes”), the user state detection unit 101 shifts the processing to step S104.

In step S104, the content generation/control unit 102 determines whether the composition of the tune by the target content data can be changed.

For example, in step S103 explained above, the user state detection unit 101 acquires a frequency of the change in the context of the user. On the other hand, the content generation/control unit 102 calculates a difference (for example, a difference in a volume level) between a part being played back and a part of a transition destination in the target content data. The content generation/control unit 102 can determine, based on the frequency of the change in the context and the calculated difference, whether the composition of the tune can be changed. For example, it is conceivable that, when the frequency of the change in the context is smaller than a frequency assumed according to the difference between the parts, the content generation/control unit 102 determines that the composition of the tune can be changed. By setting the determination condition as explained above, it is possible to prevent an excessive change in the tune to be played back.

Not only this, but, as explained with reference to FIG. 7, for example, parts that can transition to the parts may be respectively designated on the creator side. The content generation/control unit 102 can also determine a composition of a tune that can be easily changed next, based on the composition of the tune by the target content data.

When determining in step S104 that the composition of the tune can be changed (step S104, “Yes”), the content generation/control unit 102 shifts the processing to step S105. In step S105, the content generation/control unit 102 changes a parameter indicating the composition of the tune according to the context of the user and generates playback content data based on the target content data according to the changed parameter. The content generation/control unit 102 starts playback by the generated playback content data.

On the other hand, when determining in step S104 that the composition of the tune cannot be changed (step S104, “No”), the content generation/control unit 102 shifts the processing to step S106. In step S106, the content generation/control unit 102 continues the playback while maintaining the current composition of the target content data.

After step S105 or step S106 ends, the processing is returned to step S103.

(3-1-1. Example in which a Plurality of Creator Works are Used)

In the first processing example in the user terminal 10, in the above explanation, the composition of the tune is changed in one target content data created by a single creator. However, this is not limited to this example. For example, the composition of the tune by the target content data can be changed using parts of a plurality of pieces of content data including the target content data.

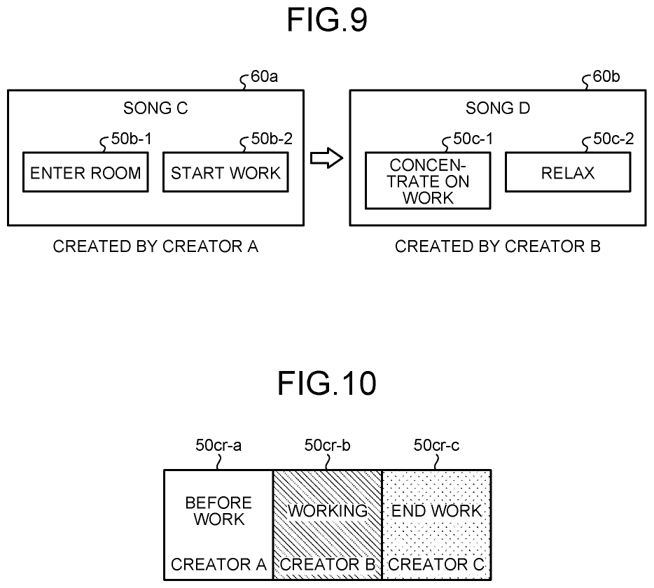

FIG. 9 is a schematic diagram illustrating an example in which a composition is changed using content data created by a plurality of creators according to the embodiment.

A creator A and a creator B who respectively create content data are considered. As illustrated in FIG. 9, it is assumed that creator A creates, as a song C, content data including a part 50b-1 and a part 50b-2 and a creator B creates, as a song D, content data including a part 50c-1 and a part 50c-2. In an example illustrated in FIG. 9, in the song C, the parts 50b-1 and 50b-2 are respectively correlated with context information “enter a room” and “start work”. On the other hand, in the song D, the parts 50c-1 and 50c-2 are respectively correlated with context information “concentrate on work” and “relax”.

After playing back the part 50b-2 of the song C according to the context information “start work”, When the context of the user transitions to a state indicated by the context information “concentrate on work”, the content generation/control unit 102 can switch the tune to be played back from the song C to the song D and play back the part 50c-1 of the song D.

Here, the content generation/control unit 102 can determine, based on the metadata of each of the content data of the song C and the content data of the song D, propriety of continuous playback of the part 50b-2 of the song C and the part 50c-1 of the song D can be performed. The content generation/control unit 102 can determine the propriety based on, for example, a genre, a tempo, a key, and the like of tunes according to the content data. In other words, it can be said that the content generation/control unit 102 selects a part compatible with a part before transition based on acoustic characteristic from parts correlated with context information that can be transitioned.

The content generation/control unit 102 can select, based on context information correlated with the parts 50b-2 and 50c-1, a part that can be transitioned. For example, the content generation/control unit 102 can select parts to indicate that transition is possible from the part 50b-2 correlated with the context information “start work” to the part 50c-1 correlated with the context information “concentrate on work” but transition is impossible to a part correlated with context information “running”.

Such information concerning transition control based on the context information correlated with the parts can be set, for example, as a parameter of content data when the creator creates the content data. Not only this, but this information concerning the transition control can also be executed in the user terminal 10.

The content generation/control unit 102 may acquire target content data and generate playback content data based on a tune, a creator, or a playback list (a list of favorite tunes) designated by the user.

FIG. 10 is a schematic diagram illustrating an example of playback content data generated based on designation by the user according to the embodiment. In this example, one tune is composed by a part 50cr-a, a part 50cr-b, and a part 50cr-c included in tunes by content data respectively created by creators A, B, and C.

For example, in the user terminal 10, the UI unit 106 acquires a list of content data stored in the content storage unit 31 from the server 30 and presents the list to the user. In the list presented by the UI unit 106, metadata and parameters of the content data are preferably displayed together with name of the creators who created the content data.

The user designates desired content data from the list presented by the UI unit 106. Furthermore, the user may input, with the UI unit 106, a time, a mood (relaxed or the like), a degree of change, and the like of a state indicated in context information in a context of the user. The UI unit 106 passes information indicating the designated content data and the information input by the user to the content generation/control unit 102. The content generation/control unit 102 acquires, from the server 30 (the content storage unit 31), the content data indicated by the information passed from the UI unit 106. The content generation/control unit 102 can generate playback content data based on context information correlated with parts of tunes by the acquired content data.

As explained above, since the content data created by the plurality of creators are mixed and used, burdens on the creators can be reduced.

### (3-1-2. Example of Content Generation Corresponding to an Experience Time)

In the first processing example in the user terminal 10, it is possible to generate playback content data corresponding to an experience time of the user.

For example, it is assumed that the user initially selects context data (a tune), a maximum experience time (a maximum playback time) of which is 16 minutes. It is also conceivable that the context of the user does not end in 16 minutes, which is the maximum experience time by the selected tune. For example, when the context of the user requires 25 minutes, playback of the tune is ended in 16 minutes from the start of the playback and the user falls into a silent state for nine minutes thereafter. Therefore, the user terminal 10 according to the embodiment sequentially estimates duration of the context of the user and changes a composition of the tune according to an estimation result.

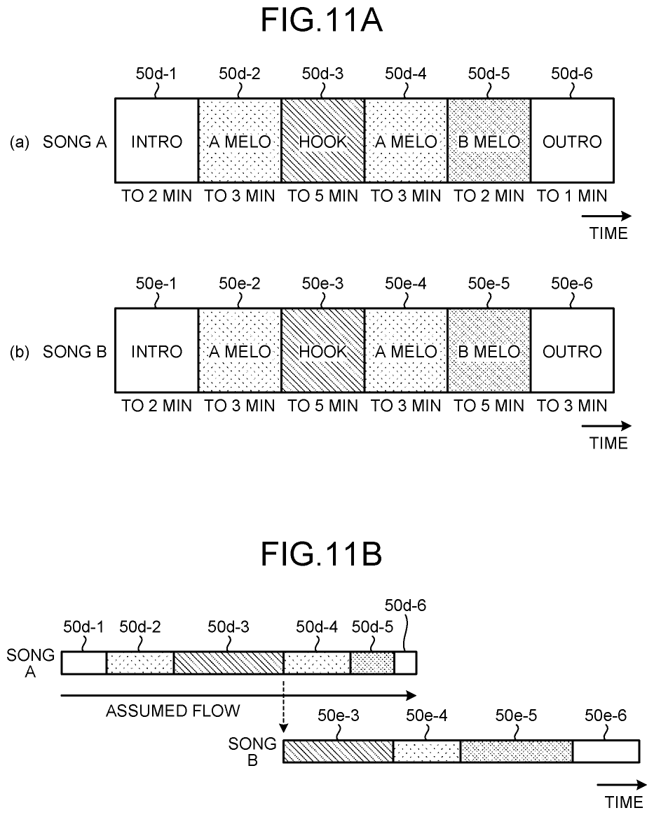

FIG. 11A and FIG. 11B are schematic diagrams for explaining generation processing for playback content data corresponding to the experience time of the user according to the embodiment. Sections (a) and (b) in FIG. 11A respectively illustrate examples of the song A and the song B as tunes based on target content data.

The song A includes a plurality of parts 50d-1 to 50d-6 arrayed in the time-series direction. In this example, the parts 50d-1 to 50d-6 are respectively “intro (prelude)”, “A Melo” (first melody), “hook”, “A Melo”, “B Melo” (second melody), and “outro (postlude)”. Maximum playback times of the parts 50d-1 to 50d-6 are respectively two minutes, three minutes, five minutes, three minutes, two minutes, and one minute. A total maximum playback time is 16 minutes and an experience time of the user by playing back the song A is 16 minutes at most. In the song A, the context information “concentrate on work” is correlated with the part 50d-3 and the context information “short break” is correlated with the part 50d-4.

The song B includes a plurality of parts 50e-1 to 50e-6 arrayed in the time-series direction. In this example, the parts 50e-1 to 50e-6 are respectively “intro (prelude)”, “A Melo”, “hook”, “A Melo”, “B Melo”, and “outro (postlude)” as in the song A in the section (a). Maximum playback times of the parts 50e-1 to 50e-6 are partially different from those of the song A and are respectively two minutes, three minutes, five minutes, three minutes, five minutes, and three minutes. A total maximum playback time is 21 minutes and an experience time of the user by playing back the song B is 21 minutes at most. In the song B, it is assumed that the context information “concentrate on work” is correlated with the part 50e-3.

FIG. 11B is a schematic diagram for explaining an example in which a composition of a tune is changed according to an estimation result of duration of the context of the user. It is assumed that the user initially selects the song A. In other words, it is assumed that the song A is context data, a maximum experience time of which is 16 minutes, and the user performs work in a flow corresponding to a maximum playback time (a maximum experience time) of the parts 50d-1 to 50d-6 in the song A.

Here, it is assumed that the user wants to perform the work even after the end of playback of the part 5d-3 in part 5d-3. According to the initial assumption, the work ends in the part 5d-3 and the user takes a short break by standing up in the next part 5d-4. For example, when a change (for example, rising) from a concentrated motion (for example, facing a desk and sitting) is not detected even when a motion of the user comes to the end of part 5d-3 as a result of sensing for the user, the user state detection unit 101 can estimate that a state of the user is further continued from a state in the context information “concentrate on work”.

In this case, for example, the content generation/control unit 102 switches a tune of a part to be played back following the part 50d-3 from the song A to the song B according to the estimation of the user state detection unit 101. The content generation/control unit 102 designates the part 5e-3 of the context information “concentrate on work” of the content data, which is the song B, as a part to be played back following the part 50d-3 of the song A and generates playback content data. Consequently, it is possible to extend an experience time for content data played back according to the context information “concentrate on work” of the user while suppressing discomfort.

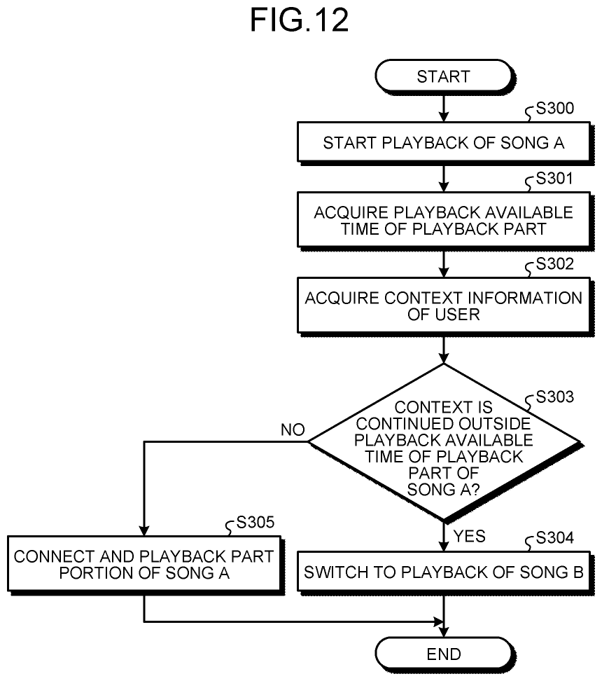

FIG. 12 is a flowchart of an example illustrating generation processing for playback content data corresponding to an experience time of the user according to the embodiment. Here, it is assumed that the song A and the song B illustrated in FIG. 11A are used as an example and the user initially selects the song A. Prior to the processing by the flow of FIG. 12, the content generation/control unit 102 acquires content data of the song A stored in the content storage unit 31 from the server 30. The content generation/control unit 102 can acquire content data of the song B stored in the content storage unit 31 from the server 30 in advance. The content generation/control unit 102 may acquire the song B according to user operation or based on metadata and parameters.

In FIG. 12, in step S300, the content generation/control unit 102 starts playback of content data by the song A. In the next step S301, the content generation/control unit 102 acquires, based on parameters of the content data, a playback available time (for example, a maximum playback time) of a part being played back. In the next step S302, the user state detection unit 101 acquires context information indicating a state of the context of the user at that point in time.

In the next step S303, the content generation/control unit 102 estimates whether a context state by the context information acquired in step S302 continues outside the playable available time of the part during the playback of the song A. When estimating that the context state continues (step S303, “Yes”), the content generation/control unit 102 shifts the processing to step S304.

In step S304, the content generation/control unit 102 selects, from the parts of the song B, a part correlated with context information corresponding to the context information correlated with the part of the song A being played back. The content generation/control unit 102 changes parameters of the song A being played back, switches the content data to be played back from the content data of the song A to content data of the song B, and plays back the selected part of the song B. In other words, it can be said that this is equivalent to the content generation/control unit 102 generating the playback content data from the content data of the song A and the content data of the song B.

On the other hand, when estimating in step S303 that the context state does not continue (step S303, “No”), the content generation/control unit 102 shifts the processing to step S305. In step S305, the content generation/control unit 102 connects the next part of the song A to the part being played back and plays back the next part.

### (3-1-3. Example of Crossfade Processing)

As explained with reference to FIG. 7 to FIG. 12, when the order of the parts in the content data is changed or the content data of a different tune is connected to the content data being played back and is played back, discomfort sometimes occurs in music to be played back in a changed part of the order or a connecting portion of the content data. In addition, when sound corresponding to a motion of the user is superimposed on music by content data being played back and is played back, discomfort sometimes occurs at timing of the superimposition of the sound.

As explained above, when a composition of a tune is changed or sound is added or deleted, if playback control is performed without considering beats, bars, tempos, keys, and the like of the tune, it is likely that a change is noticeable and an unpleasant experience is given to the user. Therefore, when the context of the user is changed, crossfade processing is performed based on the beats, the bars, the tempos, the keys, and the like of the tune at occurrence timing of a trigger corresponding to the change.

As sound or a change in sound to be subjected to the crossfade processing, for example, a sound effect, a change in a composition or sound in the same tune, and a change in sound of a connecting portion at the time when different tunes are connected are conceivable.

Among these changes, the sound effect is, for example, sound corresponding to a motion of the user. For example, it is conceivable that, when the user state detection unit 101 detects that the user has walked, the content generation/control unit 102 generates sound corresponding to landing. In the case of a sound effect triggered by a user motion, it is desirable to execute the crossfade processing with a crossfade time set short and a delay from the trigger set small.

It is desirable that the crossfade processing corresponding to the change in the composition or the sound in the same tune (see FIG. 7) is executed with a short crossfade time and at appropriate timing (for example, beat or bar) in the tune being played back.

When different tunes are connected (see FIG. 9 to FIG. 12), the crossfade processing corresponding to a change in sound in a connecting portion is desirably executed, when a composition, a key, and a tempo of the sound are greatly different, at appropriate timing (for example, beat or bar) in the tune being played back. The crossfade time may be set long to some extent or may be dynamically changed according to a state of difference or types of the tunes to be connected. The crossfade time may be set as appropriate on the user side. In some cases, it is also conceivable to further add a sound effect that clarifies a change in context. Information indicating the crossfade time is an example of information for controlling the crossfade processing for the content data.

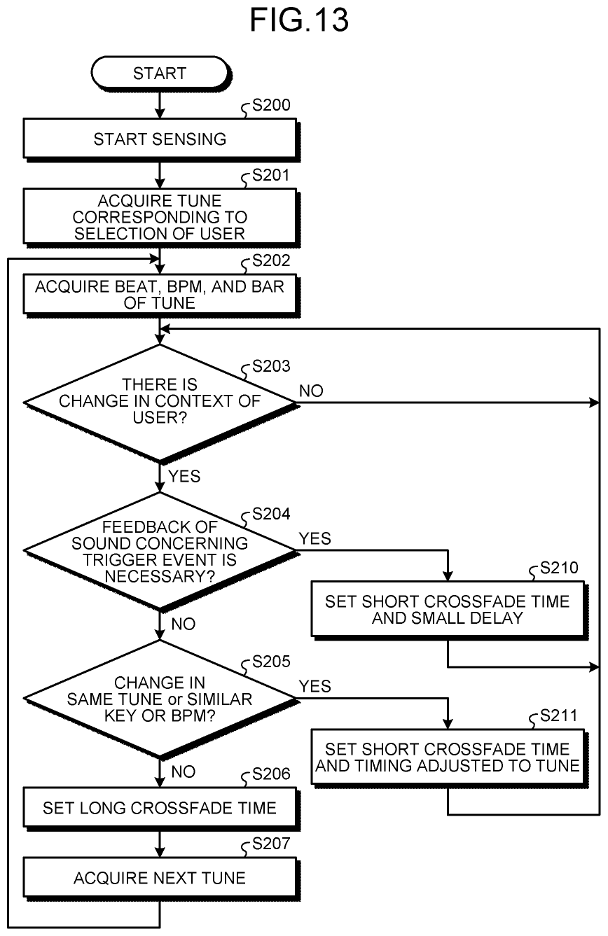

FIG. 13 is a flowchart of an example illustrating crossfade processing applicable to the embodiment.

In step S200, in the user terminal 10, the sensing unit 100 starts sensing a state of the user. The user state detection unit 101 detects a context of the user based on a result of the sensing and acquires context information. In the next step S201, the content generation/control unit 102 acquires content data (for example, tune data) stored in the content storage unit 31 from the server 30 as target content data according to an instruction corresponding to user operation by the UI unit 106.

In the next step S202, the content generation/control unit 102 acquires information such as a beat, a tempo, and a bar of a tune by the target content data based on metadata of the target content data acquired in step S201.

In the next step S203, the user state detection unit 101 determines, based on the result of the sensing by the sensing unit 100 started in step S100, whether there is a change in the context of the user. When determining that there is no change in the context of the user (step S203, “No”), the user state detection unit 101 returns the processing to step S203.

On the other hand, when determining that there is a change in the context of the user (step S203, “Yes”), the user state detection unit 101 shifts the processing to step S204 using the change in the context as a trigger for performing the crossfade processing.

In step S204, the content generation/control unit 102 determines whether feedback of sound concerning a trigger event corresponding to the trigger is necessary. For example, if the trigger event is a trigger event that generates a sound effect using a motion of the user as a trigger, the user state detection unit 101 can determine that the feedback of the sound is necessary. When determining that the feedback of the sound concerning the trigger event is necessary (step S204, “Yes”), the content generation/control unit 102 shifts the processing to step S210.

In step S210, the content generation/control unit 102 changes parameters of the content data being played back and sets the crossfade processing with a short crossfade time and a small delay from the trigger timing. The content generation/control unit 102 executes the crossfade processing according to the setting and returns the processing to step S203. Information indicating the crossfade time and the delay time for the crossfade processing is set in, for example, the creator terminal 20 and is supplied to the user terminal 10 while being included in parameters added to the content data.

On the other hand, when determining in step S204 that the feedback of the sound concerning the trigger event is unnecessary (step S204, “No”), the content generation/control unit 102 shifts the processing to step S205.

In step S205, the content generation/control unit 102 determines whether the trigger is a change in the same tune or is a change in similar keys or tempos when the tune is connected to a different tune. When determining that the trigger is the change in the same tune or is the change in the similar keys or tempos when the tune is connected to a different tune (step S205, “Yes”), the content generation/control unit 102 shifts the processing to step S211.

In step S211, the content generation/control unit 102 changes the parameters of the content data being played back and sets the crossfade processing with a short crossfade time and at timing adjusted to a beat or a bar of the tune. The content generation/control unit 102 executes the crossfade processing according to the setting and returns the processing to step S203.

On the other hand, when determining in step S205 that the trigger is not the change in the same tune (the change in the case of the connection to the different tune) and is not the change at the similar key or tempo (step S205, “No”), the content generation/control unit 102 shifts the processing to step S206.

In step S206, the content generation/control unit 102 changes the parameters of the content data being played back and sets a crossfade time longer than the crossfade time set in step S210 or step S211. In the next step S207, the content generation/control unit 102 acquires the next tune (content data). The content generation/control unit 102 executes the crossfade processing on the content data being played back and the acquired content data and returns the processing to step S202.

As explained above, when the composition of the tune is changed or the sound is added or deleted, by performing the crossfade processing based on beats, bars, tempos, keys, and the like of the tune at the generation timing of the trigger corresponding to the change, it is possible to suppress a situation in which an unpleasant experience is given to the user according to the change.

### (3-2. Second Processing Example)

Subsequently, a second processing example in the user terminal 10 according to the embodiment is explained. The second processing example is an example in which the user terminal 10 changes a composition of sound in content data to give a change to music by the content data. By changing the composition of the sound in the content data and giving the music change, it is possible to change an atmosphere of a tune to be played back. For example, when there is no change in the context of the user for a fixed time or more, the content generation/control unit 102 changes the composition of the sound in the content data and gives a music change to the content data.

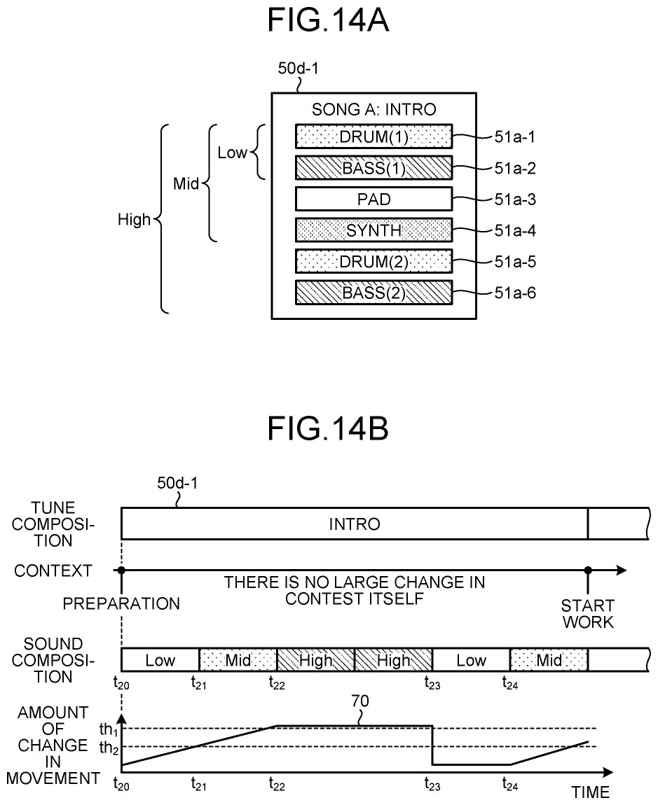

FIG. 14A and FIG. 14B are schematic diagrams for explaining a second processing example in the user terminal 10 according to the embodiment.

FIG. 14A is a diagram illustrating in more detail an example of the part 50d-1, which is an intro part of the song A illustrate in FIG. 11A. In the example illustrated in FIG. 14A, the part 50d-1 includes six tracks 51a-1 to 51a-6 respectively by different audio data. The tracks 51a-1 to 51a-6 are respectively materials of sound for composing the part 50d-1. For example, audio data are respectively allocated to the tracks 51a-1 to 51a-6.

More specifically, the tracks 51a-1 to 51a-6 are respectively materials of sound sources by a first drum (DRUM (1)), a first bass (BASS (1)), a pad (PAD), a synthesizer (SYNTH), a second drum (DRUM (2)), and a second bass (BASS (2)). Playback sound obtained by playing back the part 50d-1 is obtained by mixing sounds of the tracks 51a-1 to 51a-6. The information indicating the tracks 51a-1 to 51a-6 is an example of information indicating a combination of elements included in respective portions in a composition in the time-series direction of the target content data.

Here, a track group Low, a track group Mid, and a track group High are defined. The track group Low includes one or more tracks to be played back when an amount of change in a movement of the user is small. The track group High includes one or more tracks to be played back when the amount of change in the movement of the user is large. The track group Mid includes one or more tracks to be played back when the amount of change in the movement of the user is intermediate between the track group Low and the track group High.

In the example illustrated in FIG. 14A, the track group Low includes two tracks of tracks 51a-1 and 51a-2. The track group Mid includes four tracks of tracks 51a-1 to 51a-4. The track group High includes six tracks of tracks 51a-1 to 51a-6. In the second processing example, which one of the track groups Low, Mid, and High is played back is selected according to a user state, that is, an amount of change in a movement of the user.

Note that the track groups Low, Mid, and High can be composed as audio data obtained by mixing the included tracks. For example, the track group Low can be one audio data obtained by mixing two tracks of the tracks 51a-1 and 51a-2. The same applies to the track groups Mid and High. That is, the track group Mid is one audio data obtained by mixing the tracks 51a-1 to 51a-4 and the track group High is one audio data obtained by mixing the tracks 51a-1 to 51a-6.

FIG. 14B is a schematic diagram illustrating an example in which a composition of sound, that is, a track composition is changed within a playback period of the part 50d-1. In FIG. 14B, a tune composition, a context of the user, a sound (track) composition, and an amount of change in a movement of the user are illustrated from the top.

Here, the user terminal 10 can calculate the amount of change in the movement of the user with the user state detection unit 101 based on, for example, a sensor value of a gyro sensor or an acceleration sensor that detects the movement of the user. Not only this, but, for example, when the context of the user is “walking” or the like, the user terminal 10 can detect the movement of the user based on time intervals of steps by walking.

In the example illustrated in FIG. 14B, there is no large change in the context of the user while the intro part 50d-1 is played back. On the other hand, as indicated by a characteristic line 70, there is a change in the amount of change in the movement of the user. This means that, for example, a movement change not so large as a change in the context is detected in the user.

As explained above, when there is no change in the context, according to the amount of change amount in the movement of the user, the content generation/control unit 102 can change the parameters of the content data being played back and change a track composition. For example, the content generation/control unit 102 can perform threshold determination on the amount of change in the movement and change the track composition according to the level of the amount of change in the movement.

In the example illustrated in FIG. 14B, the content generation/control unit 102 selects the track group Low when the amount of change in the movement is less than a threshold th₂ and plays back the tracks 51a-1 and 51a-2 (times t₂₀ to t₂₁). In a period of time t₂₁ to time t₂₂, the amount of change in the movement is equal to or larger than the threshold th₂ and smaller than a threshold th₁. In the period of time t₂₁ to t₂₂, the content generation/control unit 102 selects the track group Mid and plays back the tracks 51a-1 to 51a-4. In a period from time t₂₂ to time t₂₃, the amount of change in the movement is equal to or larger than the threshold th₁. In the period of time t₂₂ to t₂₃, the content generation/control unit 102 selects the track group High and plays back the tracks 51a-1 to 51a-6. Similarly, after time t₂₃, the content generation/control unit 102 performs threshold determination on the amount of change in the movement and selects the track groups Low, Mid, and High according to a determination result.

As explained above, by changing the track composition of the content data to be played back, it is possible to give a music change to the content data and change an atmosphere of sound to be played back by the content data.

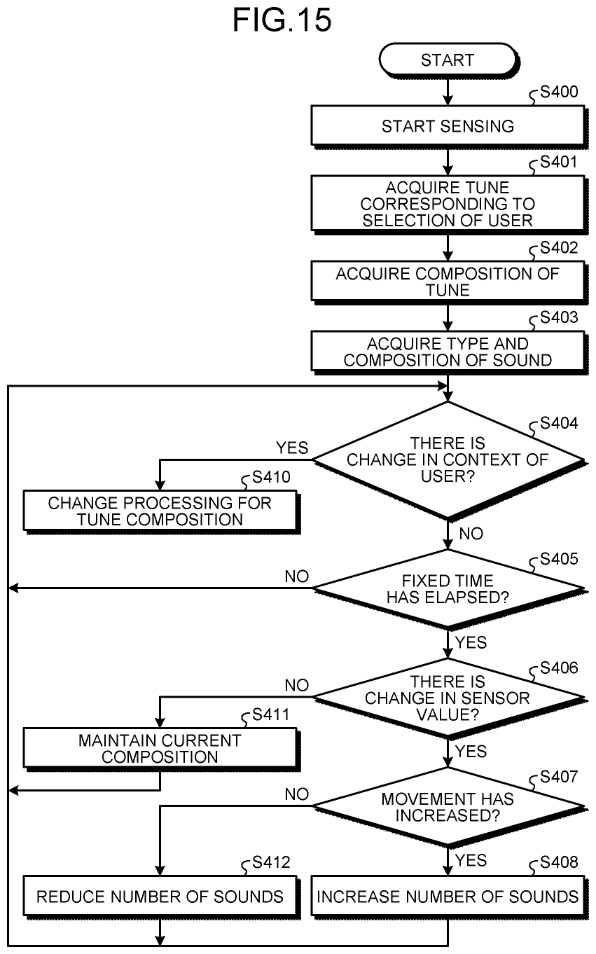

FIG. 15 is a flowchart of an example illustrating changing processing for a composition of sound by the second processing example according to the embodiment.

In step S400, in the user terminal 10, the sensing unit 100 starts sensing a state of the user. The user state detection unit 101 detects a context of the user based on a result of the sensing and acquires context information. In the next step S401, the content generation/control unit 102 acquires content data (for example, tune data) stored in the content storage unit 31 from the server 30 as target content data according to an instruction corresponding to user operation by the UI unit 106. In the next step S402, the content generation/control unit 102 acquires a composition of a tune by the target content data acquired in step S101.

In the next step S403, the content generation/control unit 102 acquires, based on, for example, metadata of the target content data, a type and a composition of sound used in the target content data. For example, the content generation/control unit 102 can acquire, based on the metadata, information concerning the track groups Low, Mid, and High explained above.

In the next step S404, the user state detection unit 101 determines, based on the result of the sensing by the sensing unit 100 started in step S400, whether there is a change in the context of the user. When determining that there is a change in the context of the user (step S404, “Yes”), the user state detection unit 101 shifts the processing to step S410. In step S410, the content generation/control unit 102 changes, according to, for example, the processing in step S104 in FIG. 8, parameters of the content data being played back and executes the changing processing for a tune composition.

On the other hand, when determining that there is no change in the context of the user (step S404, “No”), the user state detection unit 101 shifts the processing to step S405 and determines, for example, whether a fixed time has elapsed from the processing in first step S404. When determining that the fixed time has not elapsed (step S405, “No”), the user state detection unit 101 returns the processing to step S404.

On the other hand, when determining in step S405 that the fixed time has elapsed from the processing in first step S403 (step S405, “Yes”), the user state detection unit 101 shifts the processing to step S406.

In step S406, the user state detection unit 101 determines whether there is a change in a sensor value of a sensor (for example, a gyro sensor or an acceleration sensor) that detects a user motion amount. When determining that there is no change in the sensor value (step S406, “No”), the user state detection unit 101 shifts the processing to step S411. In step S411, the content generation/control unit 102 maintains a current sound composition and returns the processing to step S404.

On the other hand, when determining that there is a change in the sensor value in step S406 (step S406, “Yes”), the user state detection unit 101 shifts the processing to step S407. In step S407, the user state detection unit 101 determines whether the sensor value has changed in a direction in which a movement of the user increases. When determining that the sensor value has changed in the direction in which the movement of the user increases (step S407, “Yes”), the user state detection unit 101 shifts the processing to step S408.

In step S408, the content generation/control unit 102 controls the target content data to increase the number of sounds (the number of tracks) from the current sound composition. After the processing in step S408, the content generation/control unit 102 returns the processing to step S404.

On the other hand, when determining in step S407 that the sensor value has changed in a direction in which the movement of the user decreases (step S407, “No”), the user state detection unit 101 shifts the processing to step S412.

In step S412, the content generation/control unit 102 changes the parameters of the content data being played back and controls the target content data to reduce the number of sounds (the number of tracks) from the current sound composition. After the processing in step S412, the content generation/control unit 102 returns the processing to step S404.

Note that, in the above explanation, the processing in step S406 and step S407 may be threshold determination. For example, as explained with reference to FIG. 14B, the user state detection unit 101 may determine the presence or absence of a change in the sensor value and the magnitude of the movement using the threshold th₁ and the threshold th₂ having a value lower than the threshold th₁.

### (3-2-1. Modification of the Second Processing Example)

Subsequently, a modification of the second processing example is explained. The modification of the second processing example is an example in which the generation of the playback content data corresponding to the experience time of the user explained with reference to FIG. 11A and FIG. 11B is realized by changing a composition of sound in the content data and giving a music change.

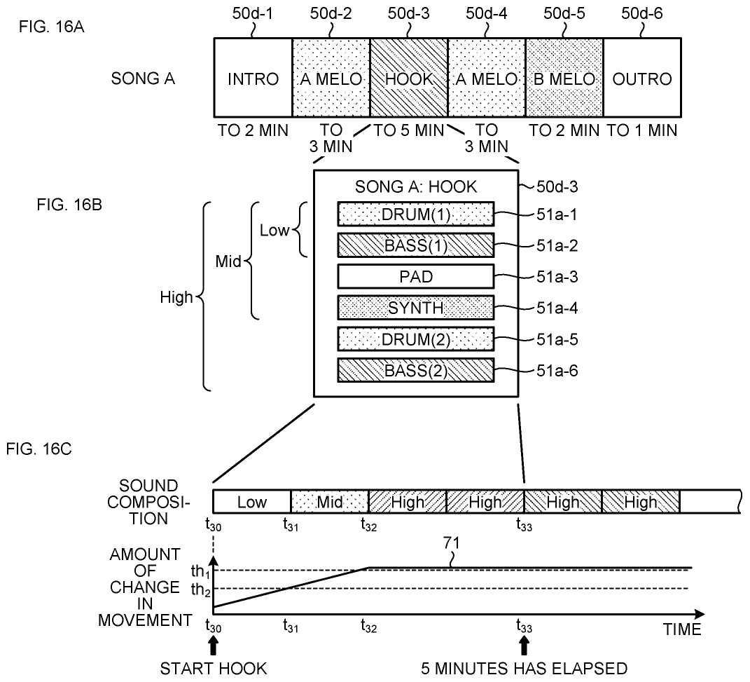

FIG. 16 is a schematic diagram for explaining the modification of the second processing example according to the embodiment. A section (a) of FIG. 16 illustrates a composition example in the time-series direction of a target tune and a section (b) illustrates a composition example of sound of the part 50d-3, which is a hook portion of the tune “song A” illustrated in the section (a).

The composition example of the sound illustrated in the section (b) corresponds to the composition illustrated in FIG. 14A and includes the tracks 51a-1 to 51a-6 based on audio data of sounds of a first drum (DRUM (1)), a first bass (BASS (1)), a pad (PAD), a synthesizer (SYNTH), a second drum (DRUM (2)), and a second bass (BASS (2)). Further, two tracks of the tracks 51a-1 and 51a-2 are set as the track group Low, four tracks of the tracks 51a-1 to 51a-4 are set as the track group Mid, and six tracks of the tracks 51a-1 to 51a-6 are set as the track group High.

A section (c) of FIG. 16 is a schematic diagram illustrating an example in which a composition of sound, that is, a track composition is changed according to a sensor value according to playback of the part 50d-3.

In this example, the playback of the part 50d-3, which is a hook portion, is started at time t₃₀. In a period of time t₃₀ to time t₃₁, since the amount of change in the movement is smaller than the threshold th₂, the content generation/control unit 102 selects the track group Low and plays back the tracks 51a-1 and 51a-2. In a period of time t₃₁ to time t₃₂, since the amount of change in the movement is equal to or larger than the threshold th₂ and smaller than the threshold th₁, the content generation/control unit 102 selects the track group Mid and plays back the tracks 51a-1 to 51a-4. After time t₃₂, since the amount of change in the movement is equal to or larger than the threshold th₁, the content generation/control unit 102 selects the track group High and plays back the tracks 51a-1 to 51a-6.

Here, according to the composition of the song A in the time-series direction, a part of the song A is switched from the part 50d-3 of the hook portion to the part 50d-4 of the A Melo portion time t₃₃ when five minutes, which is the maximum playback time of the part 50d-3, has elapsed from time t₃₀. Here, when a state in which the amount of change in the movement exceeds the threshold th₁ continues at time t₃₃, for example, the content generation/control unit 102 can determine that the concentration of the user is maintained. When the context information “start work” is correlated with the part 50d-4 of the A-Mello portion originally played back from time t₃₃, the content generation/control unit 102 can determine that the part 50d-4 is unsuitable for the user who is maintaining concentration and continuing work.

In this case, the content generation/control unit 102 can set a part to be played back at time t₃₃ as another part, context information (for example, context information “concentrate on work”) of which is correlated with the user who is working, instead of the part 550d-4. As an example, it is conceivable that the content generation/control unit 102 changes the parameters of the song A being played back and plays back the part 50e-3 of the hook portion of the song B illustrated in the section (b) of FIG. 11A from time t₃₃. In this case, the content generation/control unit 102 preferably selects the track group High in the part 50e-3.

Not only this, but the content generation/control unit 102 may extract a part from the song A being played back and play back the part from time t₃₃. For example, the content generation/control unit 102 can play back the part 50d-3, which is the hook portion of the song A, again.

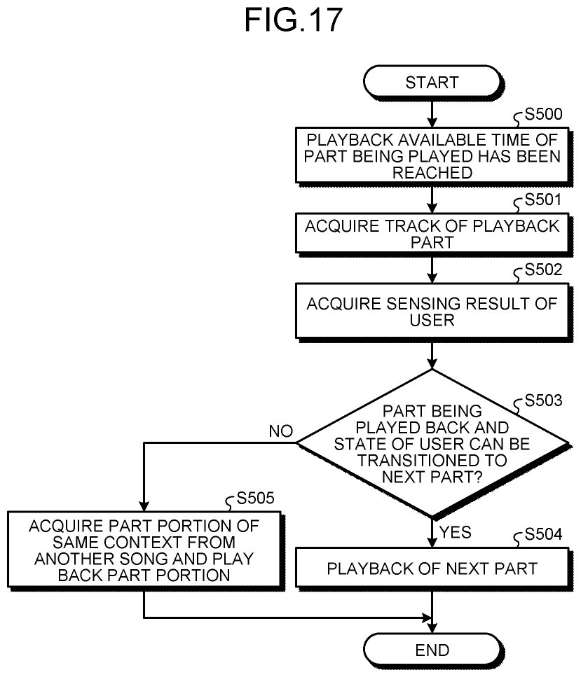

FIG. 17 is a flowchart of an example illustrating changing processing for a composition of sound according to a modification of the second processing example according to the embodiment. Note that, prior to the processing according to the flowchart in FIG. 17, it is assumed that sensing of a state of the user by the sensing unit 100 has started in the user terminal 10.

When a time in which a part being played back is played back has reached a playback available time (for example, a maximum playback time) (step S500), in the next step S501, the content generation/control unit 102 acquires tracks (a track group) composing the part being played back. In the next step S502, the content generation/control unit 102 acquires a sensing result of the user. The content generation/control unit 102 calculates an amount of change in a movement of the user based on the acquired sensing results.

In the next step S503, the content generation/control unit 102 determines whether transition to playback of the next part is possible based on the part being played back and a state of the user, for example, the amount of change in the movement of the user. When determining that the transition is possible (step S503, “Yes”), the content generation/control unit 102 shifts the processing to step S504, changes parameters of the content data being played back, and starts playback of the next part of the tune being played back. As an example, in the example illustrated in FIG. 16 explained above, if the amount of change in the movement of the user is smaller than the threshold th₁ and equal to or larger than the threshold th₂ at time t₃₃, the content generation/control unit 102 can determine that transition to the part 50d-4 of the A Melo portion is possible.

On the other hand, when determining in step S503 that transition to playback of the next part is impossible (step S503, “No”), the content generation/control unit 102 shifts the processing to step S505. In step S505, the content generation/control unit 102 changes the parameters of the content data being played back and acquires, from a tune different from the tune being played back, a part correlated with context information same as or similar to the part of the tune being played back. The content generation/control unit 102 connects the acquired part to the part being played back and plays back the part.

As explained above, in the modification of the second processing example of the embodiment, when the part being played back reaches the playback available time, for example, a part of another tune correlated with the context information same as or similar to the context information correlated with the part is connected to the part being played back and is played back. Therefore, the user can continue to maintain a current state indicated in the context information.

### (3-3. Example of a UI in the User Terminal)

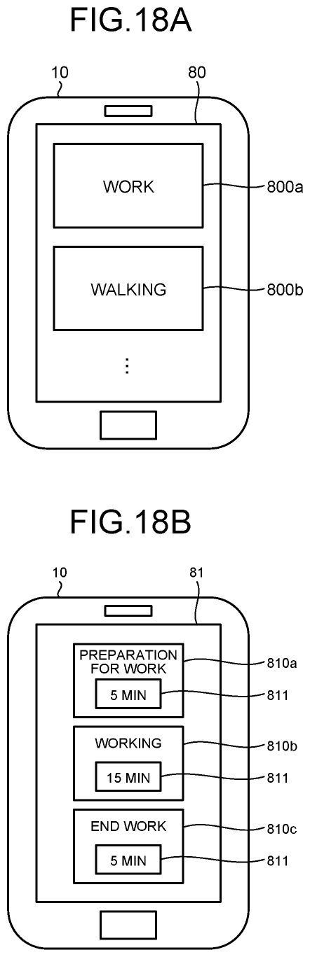

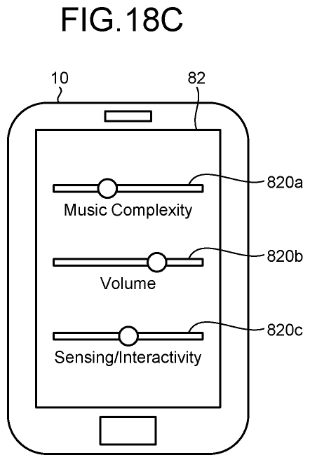

Subsequently, an example of a user interface in the user terminal 10 applicable to the embodiment is explained. FIG. 18A to FIG. 18C are schematic diagrams illustrating examples of a user interface (hereinafter, explained as a UI) in the user terminal 10 applicable to the embodiment. Screens illustrated in FIG. 18A to FIG. 18C are respectively displayed, by the UI unit 106, on the display device 1020 configuring the touch panel in the user terminal 10.

FIG. 18A illustrates an example of a context selection screen 80 for the user to select a context scheduled to be executed. In FIG. 18A, buttons 800a, 800b, . . . for selecting a context are provided on the context selection screen 80. In the example illustrated in FIG. 18A, the button 800a is provided to select “work” as the context and the button 800b is provided to select “walking” as the context.

FIG. 18B illustrates an example of a content setting screen 81 for the user to set content. The example illustrated in FIG. 18B is an example of the content setting screen 81 in the case in which, for example, the button 800a is operated on the context selection screen 80 illustrated in FIG. 18A and the context “work” is selected. In the example illustrated in FIG. 18B, regions 810a, 810b, and 810c for setting operations (scenes) in the context are provided on the content setting screen 81. For each of the regions 810a, 810b, and 810c, a region 811 for setting a time for an operation (a scene) shown in the region is provided.

The UI unit 106 requests, for example, the server 30 to transmit content data (for example, tune data) corresponding to selection and setting contents for the context selection screen 80 and the content setting screen 81. In response to this request, the server 30 acquires one or more content data stored in the content storage unit 31 and transmits the acquired content data to the user terminal 10. In the user terminal 10, for example, the UI unit 106 stores the content data transmitted from the server 30 in, for example, the storage device 1004. Not only this, but the content data acquired from the content storage unit 31 may be streamed to the user terminal 10 by the server 30.

FIG. 18C illustrates an example of a parameter adjustment screen 82 for the user to set a degree of change in parameters concerning playback of music (a tune). In the example illustrated in FIG. 18C, sliders 820a, 820b, and 820c for respectively adjusting parameters are provided on the parameter adjustment screen 82.

The slider 820a is provided to adjust a degree of music complexity as a parameter. By moving a knob of the slider 820a to the right, the music changes more intensely. The slider 820b is provided to adjust, as a parameter, volume of the entire music to be played back. The volume is increased by moving a knob of the slider 820b to the right. The slider 820c is provided to adjust a degree of interactivity (sensing) with respect to a sensor value as a parameter. By moving the knob of the slider 820c to the right, the sensitivity to the sensor value is increased, and a music change occurs according to a smaller movement of the user.

The parameters illustrated in FIG. 18C are examples and are not limited to this example. For example, it is possible to add a frequency characteristic, a dynamics characteristic, a crossfade time a (relative value), and the like as parameters for giving a music change.

### [4. Processing in the Creator Terminal According to the Embodiment]

Subsequently, processing in the creator terminal 20 according to the embodiment is explained with reference to an example of a UI in the creator terminal 20.

### (4-1. Example of a UI for Allocating Audio Data to Tracks)

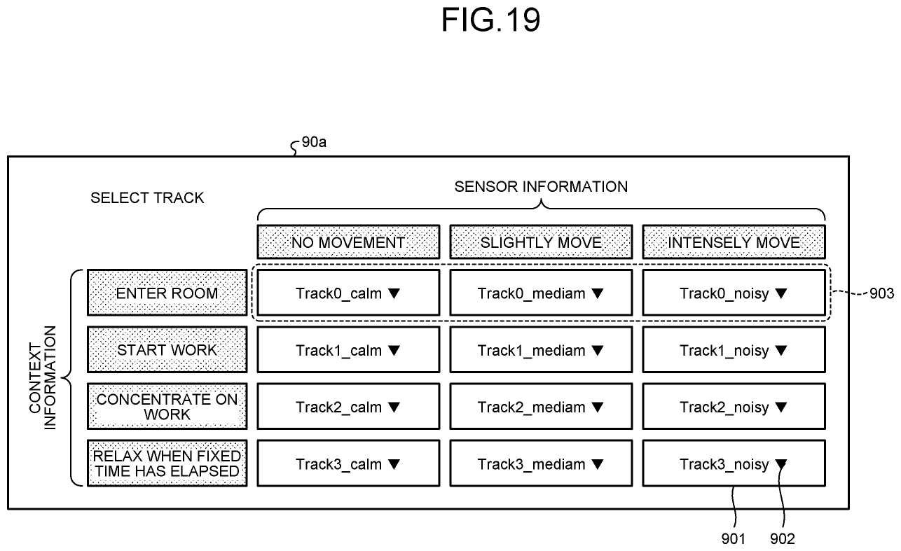

FIG. 19 is a schematic diagram illustrating an example of a track setting screen for setting a track according to the embodiment. A track setting screen 90a illustrated in FIG. 19 is generated by the UI unit 204 and displayed on the display device 2020 of the creator terminal 20.

In FIG. 19, the creator selects and sets a track with the track setting screen 90a and composes, for example, one tune data.

In the example illustrated in FIG. 19, track setting units 901 for setting tracks are arranged in a matrix array on the track setting screen 90a. In this array, a column direction indicates context information and a row direction indicates sensor information. In this example, four ways of “enter a room”, “start work”, “concentrate on work”, and “relax when a fixed time has elapsed” are set as the context information. Three ways of “no movement”, “slightly move”, and “intensely move” are set as the sensor information according to an amount of change in a movement of the user based on a sensor value. On the track setting screen 90a, the track setting unit 901 can set a track for each of the context information and the sensor information.

In the example illustrated in FIG. 19, in the track setting unit 901, by operating a button 902, it is possible to select and set a track corresponding to a position on a matrix of the track setting unit 901. As an example, according to the operation of the button 902, the UI unit 204 can make it possible to view a folder in which audio data for composing a track is stored in the storage device 2004 in the creator terminal 20. The UI unit 204 can set, as a track corresponding to a position of the track setting unit 901, the audio data selected from the folder according to the user operation.

For example, the creator can set, for each piece of the context information in a column of the sensor information “no movement”, for example, a track on which playback sound with a quiet atmosphere can be obtained. In a column of the sensor information “intensely move”, the creator can set, for each piece of the context information, for example, a track on which playback sound of an intense atmosphere can be obtained. In the column of the sensor information “slightly move”, the creator can set, for each piece of the context information, for example, a track on which playback sound with an atmosphere intermediate between the sensor information “intensely move” and the sensor information “no movement” can be obtained.

Among the track setting units 901 of the track setting screen 90a, tracks are set one by one for at least the context information, whereby one music data is composed. In other words, it can be said that the tracks set by the track setting units 901 are partial content data of a portion for content data as serving as one tune data.

Here, the creator can create audio data used as a track in advance and store the audio data in a predetermined folder in the storage device 2004. At this time, the creator can mix a plurality of audio data in advance and create the audio data as audio data of a track group. Not only this, but the UI unit 204 may start an application program for creating and editing audio data according to operation of the button 902 or the like.

Taking the composition in FIG. 14A explained above as an example, the creator mixes audio data of two tracks of the tracks 51a-1 and 51a-2, for example, for the context information “enter a room”, generates audio data of the track group Low, and stores the audio data in a predetermined folder in the storage device 2004. The audio data of the track group Low is set, for example, as a track of the sensor information “no movement”.

Similarly, the creator mixes audio data of four tracks of the tracks 51a-1 to 51a-4 for the context information “enter a room” to generate audio data of the track group Mid, and stores the generated audio data in the predetermined folder. The audio data of the track group Mid is set as, for example, a track of the sensor information “slightly move”. The creator mixes audio data of six tracks of the tracks 51a-1 to 51a-6 for the context information “enter a room” to generate audio data of the track group High and stores the generated audio data in the predetermined folder. The audio data of the track group High is set as, for example, a track of the sensor information “intensely move”.

Note that, in the track setting units 901 arranged to be aligned in the row direction according to the context information as illustrated as a range 903 in FIG. 19, it is preferable that, when tracks having the same key and tempo, the user is prevented from feeling discomfort when changing a track composition.

On the track setting screen 90a illustrated in FIG. 19, the creator needs to prepare audio data of the tracks in advance. In the example explained above, for the context information “enter a room”, the creator needs to respectively prepare audio data of six tracks of the tracks 51a-1 to 51a-6, for example, audio data by sounds of sound sources of a first drum (DRUM (1)), a first bass (BASS (1)), a pad (PAD), a synthesizer (SYNTH), a second drum (DRUM (2)), and a second bass (BASS (2)).

A method of allocating tracks to the track setting units 901 is not limited to the example explained with reference to FIG. 19. For example, it is also possible to automatically create tracks to be allocated to the track setting units 901 from audio data of a plurality of sound sources composing a certain part.

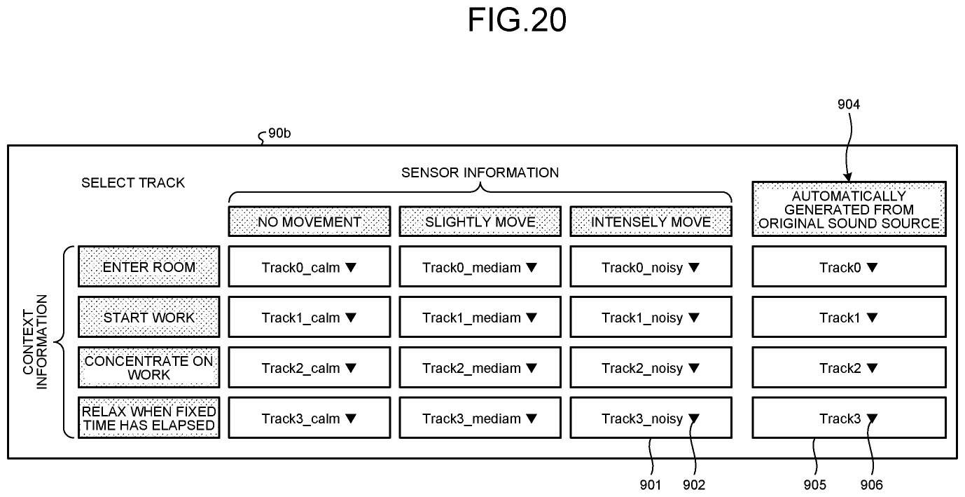

FIG. 20 is a schematic diagram illustrating an example of a track setting screen in the case in which automatic track allocation is applied according to the embodiment. A track setting screen 90b illustrated in FIG. 20 is generated by the UI unit 204 and displayed on the display device 2020 of the creator terminal 20.

Incidentally, there has been known a technique for separating audio data of a plurality of sound sources from, for example, audio data obtained by stereo-mixing the audio data of the plurality of sound sources. As an example, a learning model in which separation of individual sound sources is learned by machine learning is generated for the audio data obtained by mixing the audio data of the plurality of sound sources. By using this learning model, the audio data of the individual sound sources are separated from the audio data obtained by mixing the audio data of the plurality of sound sources.

Here, a case in which the automatic track allocation according to the embodiment is performed using this sound source separation processing is explained.

In FIG. 20, in the track setting screen 90b, a right end column 904 (automatically generated from an original sound source) is added to the track setting screen 90a illustrated in FIG. 19. In the example illustrated in FIG. 20, in the column 904, a sound source setting unit 905 is provided for the context information. In the sound source setting units 905, a folder in which the audio data obtained by mixing the audio data of the plurality of sound sources to be applied to context information corresponding thereto is stored may be enabled to be viewed by operating a button 906.

Note that the “audio data obtained by mixing” in this case is preferably, for example, data in which all tracks (audio data) used as the track groups Low, Mid, and High explained above are mixed without overlapping.

For example, the creator operates, for example, the button 906 of the sound source setting unit 905 corresponding to the context information “enter a room” in the column 904 to select audio data. The UI unit 204 passes information indicating the selected audio data to the creation unit 200.

The creation unit 200 acquires the audio data from, for example, the storage device 2004 based on the passed information and applies sound source separation processing on the acquired audio data. The creation unit 200 generates audio data corresponding to sensor information based on the audio data of the sound sources separated from the audio data by the sound source separation processing. The creation unit 200 generates, for example, audio data of the track groups Low, Mid, and High respectively from the audio data of the sound sources obtained by the sound source separation processing. The creation unit 200 allocates the generated audio data of the of the track groups Low, Mid, and High to the sensor information of the corresponding context information “enter a room”.

Note that audio data of which sound source corresponds to which track group can be set in advance. Not only this, but the creation unit 200 is also capable of automatically creating a track group based on the audio data of the sound sources obtained by the sound source separation processing.

With this configuration, for example, it is possible to automatically generate tracks to be allocated to the track setting units 901 from the stereo-mixed audio data and it is possible to reduce a burden on the creator.

Note that a method applicable to the automatic track allocation according to the embodiment is not limited to the method using the sound source separation processing. For example, audio data of a plurality of sound sources that compose certain parts may be held in a state in which multitrack, that is, mixing is not performed, and audio data corresponding to sensor information may be generated based on the audio data of the sound sources.

### (4-2. Example of an UI for Experience Time Calculation)

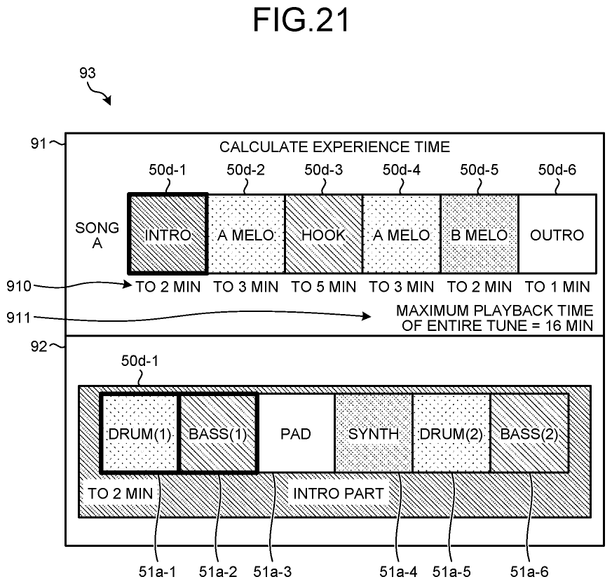

FIG. 21 is a schematic diagram illustrating an example of a UI for calculating an experience time of a tune applicable to the embodiment. An experience time calculation screen 93 illustrated in FIG. 21 is generated by the UI unit 204 and displayed on the display device 2020 of the creator terminal 20.

In FIG. 21, the experience time calculation screen 93 includes a part designation region 91 and a composition designation region 92. The part designation region 91 indicates a composition in the time-series direction of the tune. In the example illustrated in FIG. 21, in the part designation region 91, the parts 50d-1 to 50d-6 of the song A are displayed side by side in time series. In the part designation region 91, extendable time information 910 is displayed below the parts 50d-1 to 50d-6. Extendable times (two minutes, three minutes, five minutes, . . . ) displayed in the extendable time information 910 indicate maximum playback times in the case in which original experience times (playback times) of the respective parts are extended.

When any one of the parts 50d-1 to 50d-6 is selected in the part designation region 91, a track included in the designated part is displayed in the composition designation region 92. In the example illustrated in FIG. 21, the composition designation region 92 is illustrated as an example of a case in which the part 50d-1, which is an intro part, is selected in the part designation region 91.

In the example illustrated FIG. 21, as shown in the composition designation region 92, the part 50d-1 of the song A includes the tracks 51a-1 to 51a-6 by materials (for example, audio data) of sounds of a first drum (DRUM (1)), a first bass (BASS (1)), a pad (PAD), a synthesizer (SYNTH), a second drum (DRUM (2)), and a second bass (BASS (2)).

For example, in the composition designation region 92, by selecting one or a plurality of tracks among the tracks 51a-1 to 51a-6, it is possible to check playback sound in the case in which the selected tracks are combined. For example, when a plurality of tracks are selected among the tracks 51a-1 to 51a-6 in the composition designation region 92, the UI unit 204 can mix the playback sounds by the selected tracks and output mixed playback sound from, for example, the sound output device 2021.

For example, the creator can set a maximum playback time of the part 50d-1 by the selected tracks by listening to the playback sound. The creator can differentiate and play back tracks to be selected from the tracks 51a-1 to 51a-6 and set a maximum playback time of the part 50d-1 by a combination of the tracks. In the example illustrated in FIG. 21, the tracks 51a-1 and 51a-2 are selected as indicated by thick frames in the composition designation region 92 and a maximum playback time in that case is set to two minutes.

Extension of a playback time can be performed by repeating, for example, a part itself or a phrase included in the part. For example, the creator can actually edit audio data of a target part and attempt repetition and the like and can determine a maximum playback time based on a result of the attempt.

For example, on the experience time calculation screen 93 illustrated in FIG. 21, the creator respectively selects the parts 50d-1 to 50d-6 in the part designation region 91 and respectively attempts extension by combinations of tracks with the composition designation region 92. The creator can calculate maximum playback times in the combinations and, for the parts 50d-1 to 50d-6, set largest maximum playback times as maximum playback times of the parts. The maximum playback times of the parts 50d-1 to 50d-6 determined by the creator are input by, for example, a not-illustrated input unit provided in the part designation region 91. The creation unit 200 generates metadata including the maximum playback times of the parts 50d-1 to 50d-6.

For example, the UI unit 204 calculates a maximum playback time in the entire song A based on the input or determined maximum playback times of the parts 50d-1 to 50d-6 and displays the calculated maximum playback time in a display region 911. In the example illustrated in FIG. 21, the maximum playback time, that is, a maximum experience time of the song A is displayed as 16 minutes.

The set maximum playback times of the parts 50d-1 to 50d-6 of the song A are correlated with the parts 50d-1 to 50d-6 as parameters indicating the maximum experience times of the parts 50d-1 to 50d-6. Similarly, the maximum playback time of the song A calculated from the maximum playback times of the parts 50d-1 to 50d-6 is correlated with the song A as a parameter indicating the maximum experience time of the song A.

Note that, in the above explanation, the combination of the tracks in the part is changed as a parameter according to the context information and the music change is given to the tune. However, the parameter that gives the music change is not limited to the combination of the tracks. Examples of the parameter that gives the music change corresponding to the context information to the tune being played back include a combination in units of bars, a tempo, a tone (a key), a type of a musical instrument or sound in use, a type of a part (intro, A-Melo, or the like), and a type of a sound source in the part. By changing, for the tune being played back, these parameters according to the context information, it is possible to give a music change to the tune and change an atmosphere of a tune to be played back.

### (4-3. Example of a UI for Tagging Tune Data)

Subsequently, an example of a UI for tagging tune data according to the embodiment is explained. In the embodiment, for example, the portions (the parts, the audio data, and the like) composing the tune data is tagged to correlate the parts as data of one tune. Note that a tag by tagging can be included in, for example, parameters for controlling playback of content data as explained above.

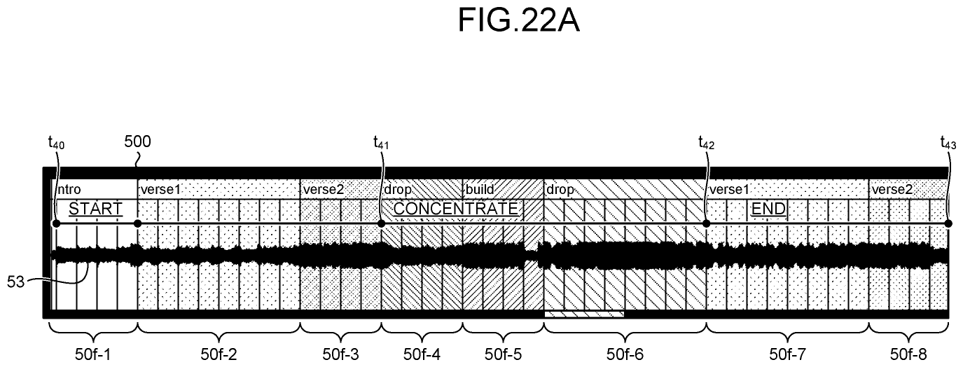

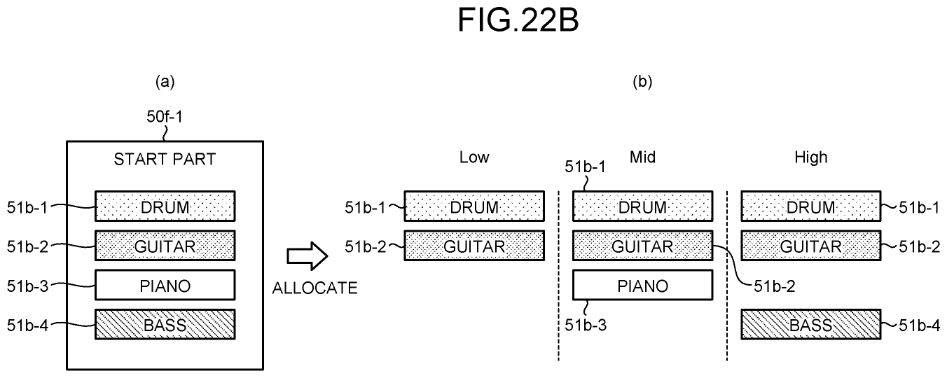

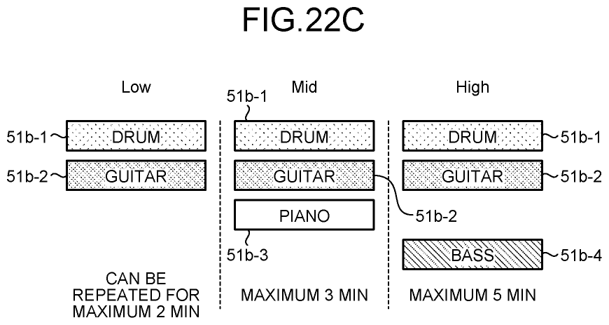

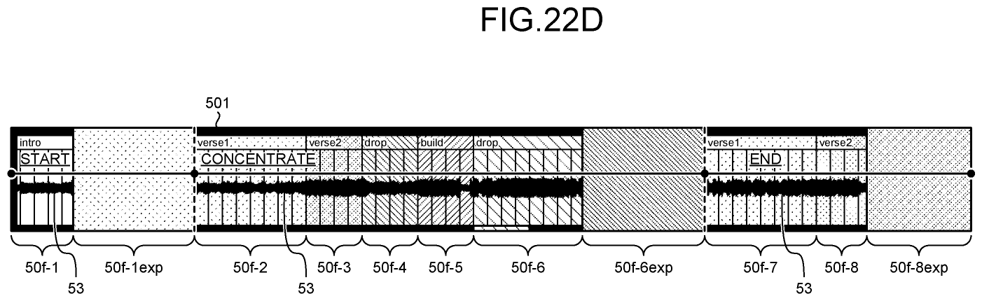

FIG. 22A is a schematic diagram for explaining registration of a material and context information for the material according to the embodiment. The UI unit 204 presents audio data 53 serving as a material to the creator using waveform display, for example, as illustrated as material display 500 in FIG. 22A. This is not limited to this example and the UI unit 204 may present the audio data 53 in another display format in the material display 500.

In the example illustrated in FIG. 22A, parts 50f-1 to 50f-8 are set for the audio data 53. The parts 50f-1 to 50f-8 may be detected, for example, by analyzing the audio data 53 with the creation unit 200 or may be manually designated from a screen (not illustrated) presented to the UI unit 204 by the creator. The attribute information addition unit 201 registers information indicating the parts 50f-1 to 50f-8 respectively as tags in the tune data in correlation with the audio data. In this case, for example, start positions (start times) in the audio data 53 of the parts 50f-1 to 50f-8 can be used as the tags.

Subsequently, the attribute information addition unit 201 correlates context information with the parts 50f-1 to 50f-8 and registers the context information in the tune data. The attribute information addition unit 201 may correlate the context information with the respective parts 50f-1 to 50f-8 or may collectively correlate one piece of context information with a plurality of parts. In the example illustrated in FIG. 22A, context information “start” is collectively correlated with the parts 50f-1 to 50f-3, context information “concentrate” is collectively correlated with parts 50f-4 to 50f-6, and context information “end” is collectively correlated with parts 50f-7 and 50f-8.

For example, the attribute information addition unit 201 correlates, with the parts 50f-1 to 50f-8, for example, as tags, information indicating correlation of the context information with the parts 50f-1 to 50f-8 and registers the information in the tune data. Not only this, but the attribute information addition unit 201 may correlate, with the audio data 53, respectively as tags, information (time t₄₀, t₄₁, t₄₂ and t₄₃) indicating start positions and end positions with which the context information is correlated.

FIG. 22B is a schematic diagram for explaining correlation between parts and parameters for giving a music change according to the embodiment. Here, a case in which the part 50f-1 included in the context information “start” illustrated in FIG. 22A is selected is explained as an example.

For example, the creation unit 200 extracts a material used in the part 50f-1 from the selected part 50f-1. In the example illustrated in FIG. 22B, as illustrated in a section (a), tracks 51b-1, 51b-2, 51b-3 and 51b-4 have been extracted from part 50f-1 (also illustrated as “start part” in the figure). In this example, the track 51b-1 is a track by sound of a sound source “DRUM” serving as a material. The track 51b-2 is a track by sound of a sound source “GUITAR” serving as a material. The track 51b-3 is a track by sound of a sound source “PIANO” serving as a material. The track 51b-4 is a track by sound of a sound source “BASS” serving as a material.

For example, the attribute information addition unit 201 correlates information indicating the tracks 51b-1 to 51b-4 with the part 50f-1 respectively as tags and registers the information in the tune data.

A section (b) of FIG. 22B illustrates an example of correlation of the tracks 51b-1 to 51b-4 with a sensor value, that is, an amount of change in a movement of the user. In this example, the track groups Low, Mid, and High selected according to the amount of change in the movement of the user explained with reference to FIG. 14A are defined. For example, the track group Low includes two tracks of the track 51b-1 and 51b-2. The track group Mid includes the tracks 51b-1 and 51b-2 and the track 51b-3. The track group High includes the tracks 51b-1, 51b-2, and 51b-4.

For example, the attribute information addition unit 201 correlates, respectively as tags, with the tracks 51b-1 to 51b-4, information indicating track groups to which the tracks 51b-1 to 51b-4 belong and registers the information in the tune data.

The attribute information addition unit 201 can correlate, in the selected part, information indicating maximum playback times with the track groups Low, Mid, and High as tags. FIG. 22C is a schematic diagram for explaining correlation of the maximum playback times with the track groups Low, Mid, and High according to the embodiment.

In the example illustrated in FIG. 22C, information (2 min, 3 min, and 5 min) indicating the maximum playback times is correlated, as tags, with the track groups Low, Mid, and High of part 50f-1 illustrated in FIG. 22B explained above. In the track group Low, further, information indicating that the part 50f-1 can be repeatedly played back for two minutes at most when the track group Low is selected is correlated as a tag. The information concerning the repeated playback is not limited to the example indicated by the times and can be indicated by using composition information of a tune, for example, in units of bars.

FIG. 22D is a schematic diagram illustrating an example of visualized display 501 obtained by visualizing the correlations explained with reference to FIG. 22A to FIG. 22C according to the embodiment. In this example, the UI unit 204 visualizes a state in which the maximum playback time explained with reference to FIG. 22C is reflected on, for example, the material display 500 illustrated in FIG. 22A and presents the visualized state as visualized display 501. Note that, here, in the parts 50f-1 to 50f-8, the largest maximum playback time among the maximum playback times set for the track groups Low, Mid, and High is adopted as the maximum playback time of the parts.

In the visualized display 501, extendable times predicted based on the maximum playback times are respectively shown as parts 50f-1exp, 50f-6exp, and 50f-8exp for convenience. The parts 50f-1exp, 50f-6exp and 50f-8exp respectively show the extendable times for the parts 50f-1, 50f-6 and 50f-8. This example indicates that the start position of the context information “concentrate” has been changed immediately after the part 50f-1exp.

4-4. Example of Correlation of Context Information with Tune Data

Subsequently, an example of correlation of context information according to the embodiment is explained. In the above explanation, the context information is set with the motion in the context of the user as the trigger. However, this is not limited to this example. As a type of the trigger of the context that can be correlated with the context information, the following triggers are conceivable in order from a type having the lowest trigger occurrence rate.

As user-induced triggers, the following triggers are conceivable.

### Selection of Equipment for Playing Back Content Data.

The attribute information addition unit 201 can set, as a trigger of a context that can be correlated with context information, for example, the user having selected a headphone, an earphone, a speaker, or the like as a sound output apparatus for playing back context data.

### Selection of Context by the User.

The attribute information addition unit 201 can set, as a trigger of a context that can be correlated with context information, for example, an action of the user such as the user starting work, starting running, or falling asleep. For example, it is conceivable that the attribute information addition unit 201 sets, as a trigger of a context that can be correlated with context information, operation of context selection on the context selection screen 80 in the user terminal 10 illustrated in FIG. 18A.

### State of a Context.

The attribute information addition unit 201 can set, as a trigger of a context that can be correlated with context information, transition of a state of a context corresponding to a sensor value or an elapsed time. For example, when the context of the user is “work”, it is conceivable that the attribute information addition unit 201 sets, as a trigger of a context that can be correlated with context information, before the start of work, during work, work end, or the like detected with a sensing result of the sensing unit 100 or elapse of time.

As a trigger due to a detected event, the following triggers are conceivable.

### Change in Weather.

The attribute information addition unit 201 can set, as a trigger of a context that can be correlated with context information, for example, a change from clear sky to cloudy sky, and, further, a change in weather such as rainfall or thunderstorm, acquired as an event. The user terminal 10 is capable of grasping weather based on an image captured by a camera included in the sensor unit 1010, weather information that can be acquired via the network 2, and the like.
Time.

The attribute information addition unit 201 can set a preset time as a trigger of a context that can be correlated with context information.
Place.

The attribute information addition unit 201 can set a preset place as a trigger of a context that can be correlated with context information. For example, it is conceivable that the context information A and the context information B are respectively correlated in advance with the rooms A and B used by the user.
Action of the user.

The attribute information addition unit 201 can set, as a trigger of a context that can be correlated with context information, a large action equal to or larger than a certain degree such as standing, sitting, or walking by the user acquired by the user state detection unit 101 based on a sensing result by the sensing unit 100.

As an extension example of the trigger, information acquired from equipment other than the user terminal 10 can be set as a trigger of a context that can be correlated with context information. The attribute information addition unit 201 can set, as a trigger of a context that can be correlated with context information, for example, a trigger detected by linking the user terminal 10 and a sensor outside the user terminal 10. The attribute information addition unit 201 can set, as a trigger of a context that can be correlated with context information, for example, information based on a profile or schedule information of the user. It is conceivable that the profile and the schedule information of the user are acquired from, for example, a separate application program installed in the user terminal 10.

Among the user-induced triggers, the following triggers are conceivable as triggers having higher occurrence rates.

### A State of the User Estimated Based on a Result of Sensing by the Sensing Unit 100.

This is equivalent to the example described with reference to FIG. 7 to FIG. 17 and the like and is used as a trigger of a context in which a detection result of a degree of concentration and intensity of a movement of the user can be correlated with context information in addition to the large action equal to or larger than a certain degree such as standing, sitting, or walking explained above. The attribute information addition unit 201 can set, as a trigger of a context that can be correlated with context information, a determination result of a degree of awakening of the user determined by the user state detection unit 101 based on a result of sensing by the sensing unit 100. For example, it is conceivable that the user state detection unit 101 determines the degree of awakening by detecting a shake of the head, blinking, or the like of the user based on a result of sensing by the sensing unit 100.

### (4-5. Variations of Tagging for Tune Data)

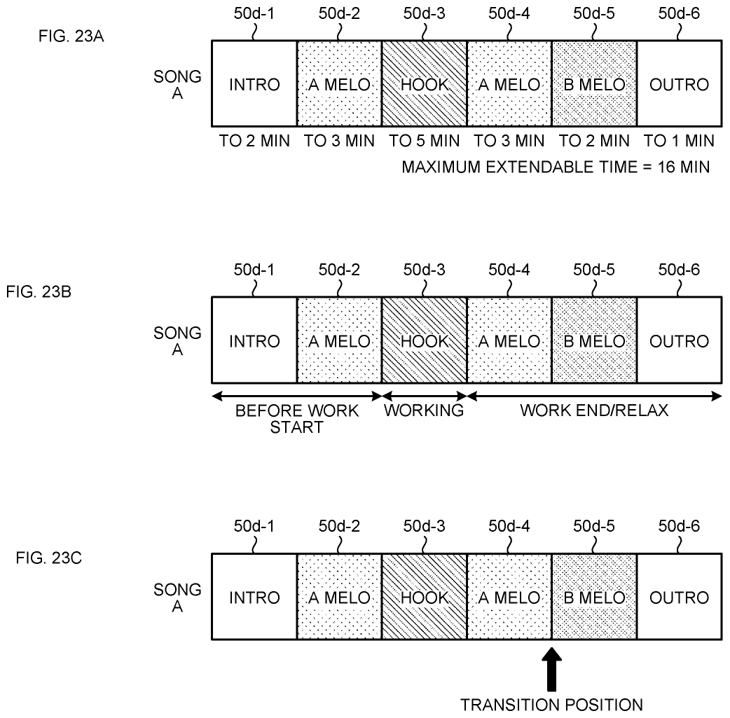

Subsequently, variations of tagging for tune data according to the embodiment are explained. FIG. 23 is a schematic diagram illustrating a variation of tagging for a created material (tune data) according to the embodiment.

A section (a) of FIG. 23 corresponds to FIG. 11A and the like explained above. For example, the creation unit 200 extracts parts from tune data, calculates maximum playback times of the respective parts, and calculates a maximum playback time in an entire tune from the obtained maximum playback times. In this example, it is assumed that maximum playback times of the parts 50d-1 to 50d-6 of the song A are respectively two minutes, three minutes, five minutes, three minutes, two minutes, and one minute and a maximum playback time of the entire song A is 16 minutes. The maximum playback time of the entire tune is a maximum extension time in which a playback time of the tune can be extended. The attribute information addition unit 201 correlates the maximum playback time of the parts 50d-1 to 50d-6 and the maximum playback time of the entire tune with the tune data of the tune as tags.

A section (b) of FIG. 23 illustrates correlation of context information for parts extracted from tune data. In this example, context information “before work start” is correlated with a set of the parts 50d-1 and 50d-2 in the song A and the context information “working” is correlated with the part 50d-3. Context information “work end/relax” is correlated with a set of the parts 50d-4 to 50d-6 in the song A. The attribute information addition unit 201 correlates these kinds of context information with the sets by the parts 50d-1 to 50d-6 of the song A as tags. Not only this, but the context information may be individually tagged to the respective parts 50d-1 to 50d-6.

A section (c) of FIG. 23 illustrates an example of tagging concerning a special trigger event. In this example, when a specific event is detected during playback of a tune, a playback position is transitioned to a specific transition position of the tune with the detection of the specific event as a trigger. In the example illustrated in the figure, when a specific event such as “user rises” is detected during playback of the song A, the content generation/control unit 102 transitions a playback position to the end of the part 50d-4 designated in advance as a transition position. For example, the attribute information addition unit 201 tags information indicating the transition position and information indicating the specific trigger for transitioning the playback position with tune data of the tune (the song A).

A specific context can be tagged to the tune. For example, the attribute information addition unit 201 correlates the context “work” with the song A and tags information indicating the context “work” with the tune data of the song A.

Further, the attribute information addition unit 201 can tag, in a certain tune, with tune data of the tune, for example, a threshold for determining whether to transition to playback of the next part based on a sensor value of a result of sensing for the user by the sensing unit 100. At this time, for example, taking the song A in FIG. 23 as an example, the attribute information addition unit 201 can tag information indicating different thresholds with the respective parts 50d-1 to 50d-6.

### (4-6. Variations of a Music Change)

In the above explanation, the music change is given to the tune by changing, for the tune being played back, the time-series composition of the tune or the composition of the sound in the part of the tune according to the context information or the sensor value. A method of giving a music change to a tune is not limited to the change of the time-series composition of the tune and the change of the composition of the sound in the part of the tune.

As a further method of giving a music change to a tune, it is conceivable to use the following method in addition to the change of the time-series composition of the tune and the change of the composition of the sound in the part of the tune explained above. Note that, in the following explanation, it is assumed that kinds of processing for giving a music change are executed in the creator terminal 20. However, this is not limited to this example. The kind of processing can also be executed in the user terminal 10.

For example, in the creator terminal 20, the creation unit 200 can give a music change to a tune using a change of a sound image position in an object-based sound source (an object sound source) and a change of sound image localization.

Note that the object sound source is one of 3D audio contents having a realistic feeling and is obtained by grasping, as one sound source (an object sound source), one or a plurality of audio data serving as materials of sound and adding, for example, meta information including position information to the object sound source. The object sound source including the position information as the meta information is capable of localizing the sound image by the object sound source in the position based on the position information or moving the localization of the sound image on a time axis by decoding the meta information to be added and playing back the meta information in a speech system corresponding to the object-based sound. Consequently, it is possible to express realistic sound.

The creation unit 200 can give a music change to a tune by changing sound volume or a tempo when the tune is played back. Further, the creation unit 200 can give a music change to the tune by superimposing a sound effect on playback sound of the tune.

Further, the creation unit 200 can give a music change to the tune by adding sound to the tune anew. As an example, the creation unit 200 is capable of analyzing materials (audio data) composing, for example, a predetermined part of the tune to detect a tone (a key), a melody, or a phrase and generating an arpeggio or a chord in the part based on the detected tone, melody, or phrase.

Furthermore, the creation unit 200 can give a music change to a tune of tune data by giving an acoustic effect to materials of the tune data. As the acoustic effect, a change of ADSR (Attack-Decay-Sustain-Release), addition of reverb sound, a change of a level corresponding to a frequency band by an equalizer, a change of dynamics by a compressor or the like, addition of a delay effect, and the like are conceivable. These acoustic effects may be given to each of the materials included in the tune data or may be given to audio data obtained by mixing the materials.

Note that the effects described in this specification are only illustrations and are not limited. Other effects may be present.

Note that the present technique can also take the following configurations.
(1) An information processing apparatus comprising:
   a content acquisition unit that acquires target content data;
   a context acquisition unit that acquires context information of a user; and a generation unit that generates, based on the target content data and the context information, playback content data in which parameters are changed in order to control playback of the target content data.
(2) The information processing apparatus according to the above (1), wherein
   the parameters include at least one of information indicating a composition in a time-series direction of the target content data and information indicating a combination of elements included in respective portions in the composition.
(3) The information processing apparatus according to the above (1) or (2), wherein
   the generation unit changes the parameters based on a change of the context information acquired by the context acquisition unit.
(4) The information processing apparatus according to any one of the above (1) to (3), wherein
   the context acquisition unit acquires at least a change of a position of the user as the context information.
(5) The information processing apparatus according to any one of the above (1) to (4), wherein
   the parameter includes information for controlling crossfade processing for content data, and
   when playback order of portions in a composition of the target content data is changed, the generation unit changes the parameters to generate the playback content data in which the crossfade processing is applied to at least one of changed portions in which the playback order is changed.
(6) The information processing apparatus according to the above (5), wherein
   the generation unit sets a time of the crossfade processing in a case in which the crossfade processing is applied to the target content data shorter than a time in a case in which the crossfade processing is applied to a connection portion of the target content data and another target content data to be played back following the target content data.
(7) The information processing apparatus according to the above (6), wherein,
   when the crossfade processing is applied to the target content data,
   the generation unit
   applies the crossfade processing at timing corresponding to a predetermined unit in a time-series direction in the target content data when applying the crossfade processing according to a composition in the time-series direction of the target content data, and
   applies the crossfade processing at timing corresponding to a motion of the user when applying the crossfade processing according to the motion of the user.
(8) The information processing apparatus according to any one of the above (1) to (6), wherein
   the parameters include information respectively indicating a maximum playback time of portions in a composition in a time-series direction of the target content data, and
   when a playback time of the portion being played back in the composition of the target content data exceeds the maximum playback time corresponding to the portion, the generation unit changes the parameters to generate the playback content data in which a playback target is transitioned to another target content data different from the target content data.
(9) The information processing apparatus according to any one of the above (1) to (8), wherein
   the target content data is at least one of music data for playing back music, moving image data for playing back a moving image, and voice data for playing back voice,
   the content acquisition unit further acquires metadata concerning the target content data, the metadata including at least one of information indicating a composition in a time-series column direction, tempo information, information indicating a combination of sound materials, and information indicating a type of the music data, and
   the generation unit further changes the parameters based on the metadata.
(10) The information processing apparatus according to the above (9), wherein
   the metadata includes, when the target content data is object sound source data, position information of object sound sources composing the target content data.
(11) The information processing apparatus according to any one of the above (1) to (10), further comprising
   a presentation unit that presents, to the user, a user interface for setting a degree of the change of the parameters according to user operation.
(12) An information processing method executed by a processor, comprising:
   a content acquisition step of acquiring target content data;
   a context acquisition step of acquiring context information of a user; and
   a generation step of generating, based on the target content data and the context information, playback content data in which parameters for controlling playback of the target content data is changed.
(13) An information processing program for causing a computer to execute:
   a content acquisition step of acquiring target content data;
   a context acquisition step of acquiring context information of a user; and
   a generation step of generating, based on the target content data and the context information, playback content data in which parameters for controlling playback of the target content data is changed.
(14) An information processing apparatus comprising:
   a control unit that divides content data into a plurality of portions based on a composition in a time-series direction and correlates context information with each of the divided plurality of portions according to user operation.
(15) The information processing apparatus according to the above (14), wherein
   the control unit correlates, according to user operation, with the context information, a plurality of partial content data having a common playback unit in the time-series direction, respectively having different data composition, and including different numbers of materials.
(16) The information processing apparatus according to the above (15), further comprising
   a separation unit that separates materials from content data, wherein
   the separation unit generates the plurality of partial content data based on each of the materials separated from one content data.
(17) The information processing apparatus according to any one of the above (14) to (16), wherein
   the control unit generates, for each of the plurality of portions, metadata including information indicating a playback time period of the portion.
(18) The information processing apparatus according to the above (17), wherein
   the control unit generates, for a predetermined portion among the plurality of portions, parameters including information indicating a maximum playback time obtained by adding an extendable time to the playback time of the predetermined portion.
(19) The information processing apparatus according to any one of the above (14) to (18), wherein
   the control unit generates, for each of the plurality of portions, parameters including information indicating a transition destination corresponding to a specific event.
(20) An information processing method executed by a processor, including:
   a dividing step of dividing content data into a plurality of portions based on a composition in a time-series direction; and
   a control step of correlating, according to user operation, the context information with each of the plurality of portions divided by the division step.
(21) An information processing program for causing a computer to execute:
   a dividing step of dividing content data into a plurality of portions based on a composition in a time-series direction; and
   a control step of correlating, according to user operation, the context information with each of the plurality of portions divided by the division step.
(22) An information processing system comprising:
   a first terminal device including
   a control unit that divides content data into a plurality of portions based on a composition in a time-series direction and correlates context information with each of the divided plurality of portions according to user operation; and
   a second terminal device including:
   a content acquisition unit that acquires target content data;
   a context acquisition unit that acquires the context information of a user; and
   a generation unit that generates, based on the target content data and the context information, playback content data in which a parameter for controlling playback of the target content data is changed.

### REFERENCE SIGNS LIST

1 INFORMATION PROCESSING SYSTEM
2 NETWORK
10 USER TERMINAL
20 CREATOR TERMINAL
30 SERVER
31 CONTENT STORAGE UNIT
50a-1, 50a-2, 50a-3, 50a-4, 50a-5, 50a-6, 50b-1, 50b-2, 50c-1, 50c-2, 50cr-a, 50cr-b, 50cr-c, 50d-1, 50d-2, 50d-3, 50d-4, 50d-5, 50d-6, 50e-1, 50e-2, 50e-3, 50e-4, 50e-5, 50e-6, 50f-1, 50f-1exp, 50f-2, 50f-3, 50f-4, 50f-5, 50f-6, 50f-6exp, 50f-7, 50f-8, 50f-8exp PART
51a-1, 51a-2, 51a-3, 51a-4, 51a-5, 51a-6, 51b-1, 51b-2, 51b-3, 51b-4 TRACK
80 CONTEXT SELECTION SCREEN
81 CONTENT SETTING SCREEN
82 PARAMETER ADJUSTMENT SCREEN
90a, 90b TRACK SETTING SCREEN
93 EXPERIENCE TIME CALCULATION SCREEN
100 SENSING UNIT
101 USER STATE DETECTION UNIT
102 CONTENT GENERATION/CONTROL UNIT
106, 204 UI UNIT
200 CREATION UNIT
201 ATTRIBUTE INFORMATION ADDITION UNIT
901 TRACK SETTING UNIT
905 SOUND SOURCE SETTING UNIT

1. An information processing apparatus comprising:
a content acquisition unit that acquires target content data;
a context acquisition unit that acquires context information of a user; and
a generation unit that generates, based on the target content data and the context information, playback content data in which parameters are changed in order to control playback of the target content data.

2. The information processing apparatus according to claim 1, wherein
the parameters include at least one of information indicating a composition in a time-series direction of the target content data and information indicating a combination of elements included in respective portions in the composition.

3. The information processing apparatus according to claim 1, wherein
the generation unit changes the parameters based on a change of the context information acquired by the context acquisition unit.

4. The information processing apparatus according to claim 1, wherein
the context acquisition unit acquires at least a change of a position of the user as the context information.

5. The information processing apparatus according to claim 1, wherein
the parameter includes information for controlling crossfade processing for content data, and
when playback order of portions in a composition of the target content data is changed, the generation unit changes the parameters to generate the playback content data in which the crossfade processing is applied to at least one of changed portions in which the playback order is changed.

6. The information processing apparatus according to claim 5, wherein
the generation unit sets a time of the crossfade processing in a case in which the crossfade processing is applied to the target content data shorter than a time in a case in which the crossfade processing is applied to a connection portion of the target content data and another target content data to be played back following the target content data.

7. The information processing apparatus according to claim 6, wherein,
when the crossfade processing is applied to the target content data,
the generation unit
applies the crossfade processing at timing corresponding to a predetermined unit in a time-series direction in the target content data when applying the crossfade processing according to a composition in the time-series direction of the target content data, and
applies the crossfade processing at timing corresponding to a motion of the user when applying the crossfade processing according to the motion of the user.

8. The information processing apparatus according to claim 1, wherein
the parameters include information respectively indicating a maximum playback time of portions in a composition in a time-series direction of the target content data, and
when a playback time of the portion being played back in the composition of the target content data exceeds the maximum playback time corresponding to the portion, the generation unit changes the parameters to generate the playback content data in which a playback target is transitioned to another target content data different from the target content data.

9. The information processing apparatus according to claim 1, wherein
the target content data is at least one of music data for playing back music, moving image data for playing back a moving image, and voice data for playing back voice,
the content acquisition unit further acquires metadata concerning the target content data, the metadata including at least one of information indicating a composition in a time-series column direction, tempo information, information indicating a combination of sound materials, and information indicating a type of the music data, and
the generation unit further changes the parameters based on the metadata.

10. The information processing apparatus according to claim 9, wherein
the metadata includes, when the target content data is object sound source data, position information of object sound sources composing the target content data.

11. The information processing apparatus according to claim 1, further comprising
a presentation unit that presents, to the user, a user interface for setting a degree of the change of the parameters according to user operation.

12. An information processing method executed by a processor, comprising:
a content acquisition step of acquiring target content data;
a context acquisition step of acquiring context information of a user; and
a generation step of generating, based on the target content data and the context information, playback content data in which parameters for controlling playback of the target content data is changed.

13. An information processing program for causing a computer to execute:
a content acquisition step of acquiring target content data;
a context acquisition step of acquiring context information of a user; and
a generation step of generating, based on the target content data and the context information, playback content data in which parameters for controlling playback of the target content data is changed.

14. An information processing apparatus comprising:
a control unit that divides content data into a plurality of portions based on a composition in a time-series direction and correlates context information with each of the divided plurality of portions according to user operation.

15. The information processing apparatus according to claim 14, wherein
the control unit correlates, according to user operation, with the context information, a plurality of partial content data having a common playback unit in the time-series direction, respectively having different data composition, and including different numbers of materials.

16. The information processing apparatus according to claim 15, further comprising a separation unit that separates materials from content data, wherein
the separation unit generates the plurality of partial content data based on each of the materials separated from one content data.

17. The information processing apparatus according to claim 14, wherein
the control unit generates, for each of the plurality of portions, metadata including information indicating a playback time period of the portion.

18. The information processing apparatus according to claim 17, wherein
the control unit generates, for a predetermined portion among the plurality of portions, parameters including information indicating a maximum playback time obtained by adding an extendable time to the playback time of the predetermined portion.

19. The information processing apparatus according to claim 14, wherein
the control unit generates, for each of the plurality of portions, parameters including information indicating a transition destination corresponding to a specific event.

20. An information processing system comprising:
a first terminal device including
a control unit that divides content data into a plurality of portions based on a composition in a time-series direction and correlates context information with each of the divided plurality of portions according to user operation; and
a second terminal device including:
a content acquisition unit that acquires target content data;
a context acquisition unit that acquires the context information of a user; and
a generation unit that generates, based on the target content data and the context information, playback content data in which a parameter for controlling playback of the target content data is changed.
